(19) United States
(12) Patent Application Publication
(10) Pub. No.: US 2012/0061324 A1
(43) Pub. Date: Mar. 15, 2012

(54) ELEMENT REMOVAL PROCESS AND APPARATUS

(75) Inventors: Steven A. Bouse, Elmhurst, IL (US); Kurt H. Schild, III, Wadsworth, IL (US); Terrence P. Kane, Wheaton, IL (US)

(73) Assignee: Global Material Technologies, Inc., Buffalo Grove, IL (US)

(21) Appl. No.: 13/222,875

(22) Filed: Aug. 31, 2011

Related U.S. Application Data
(63) Continuation-in-part of application No. 12/903,918, filed on Oct. 13, 2010.
Application No. 12/903,918 is a continuation-in-part of application No. 12/058,609, filed on Mar. 28, 2008, now Pat. No. 8,025,800.
Application No. 12/058,609 is a continuation-in-part of application No. 13/051,318, filed on Mar. 18, 2011.
(60) Provisional application No. 61/351,226, filed on Jun. 3, 2010.

(51) Int. Cl. C02F 1/42; B01D 39/00; B01D 29/07; B01D 39/10

(52) U.S. Cl. 210/681; 210/494.2

(57) ABSTRACT

A process and apparatus for removing elements is described herein.

### CROSS-RELATED APPLICATIONS

The present application claims priority as a continuation-in-part from U.S. application Ser. No. 12/903,918, filed Oct. 13, 2010, which is a continuation-in-part from U.S. application Ser. No. 12/058,609, filed Mar. 28, 2008, and claims priority as a continuation-in-part from U.S. application Ser. No. 13/051,318, filed Mar. 18, 2011, which claims priority from U.S. Provisional Ser. No. 61/351,226, filed Jun. 3, 2010, all herein incorporated by reference.

### BACKGROUND OF THE INVENTION

The field of the invention is a process and apparatus for the removal of elements from water, and more particularly the removal of contaminants, such as selenium.

Selenium is a naturally occurring metalloid element having atomic number 34 and an atomic weight of 78.96. Selenium is widely dispersed in igneous rock. Selenium also appears in large quantities, but in low concentrations, in sulfide and porphyry copper deposits. Moreover selenium is widely associated with various types of sedimentary rock. Inorganic selenium is most commonly found in four oxidation states (Se⁶⁺, Se⁴⁺, Se⁰, and Se²⁻). Selenate (SeO₄²⁻, Se(VI)) and selenite (SeO₃²⁻, Se(IV)) are highly water soluble. Elemental selenium (Se⁰) is insoluble in water.

Selenium is a common water contaminant throughout the United States and the world and represents a major environmental problem. Human related selenium release originates from many sources including mining operations, mineral processing, abandoned mine sites, petroleum processing, and agricultural run-off. The principal sources of selenium in mining are copper and uranium bearing ores and sulfur deposits. Selenium is commonly found in these mining wastewaters in concentrations ranging from a few micrograms per liter up to more than 12 mg/L. In precious metals operations, waste and process water and heap leachate solutions may contain selenium at concentrations up to 30 mg/L. It has been observed that concentrations of selenate as low as 10 μg/L in water can cause death and birth deformities in waterfowl; therefore, the established regulatory limit is 5 μg/L. Most of these mining operations, including both metal and non-metal mining operations, will need inexpensive and effective selenium removal processes to meet discharge and closure requirements. Additionally, the selenium removal difficulties include the different dissolved species, no direct precipitation chemistries, difficulty of reducing selenate, and sulfate interference. The present invention attempts to solve these problems, as well as others.

### SUMMARY OF THE INVENTION

The foregoing and other features and advantages of the invention are apparent from the following detailed description of exemplary embodiments, read in conjunction with the accompanying drawings. The detailed description and drawings are merely illustrative of the invention rather than limiting, the scope of the invention being defined by the appended claims and equivalents thereof. A process and apparatus for removing elements is described herein.

### BRIEF DESCRIPTION OF THE FIGURES

The foregoing summary, as well as the following detailed description of preferred embodiments of the invention, will be understood when read in conjunction with the appended drawings. For the purpose of illustrating the invention, there is shown in the drawings embodiments which are presently preferred. It should be understood, however, that the invention is not limited to the precise arrangements and configurations shown.

FIG. 1 is a schematic view of one embodiment.

FIG. 2A is a perspective view of one embodiment of the Zero-Valent Iron Fiber (“ZVIF”) Packing; FIG. 2B is a perspective view of another embodiment of the ZVIF Packing; and FIG. 2C is a perspective view of another embodiment of the ZVIF Packing

FIG. 3A is a light microscope image of view of the ZVIF packing after selenium removal; FIG. 3B is an enlarged view of the metal fiber; and FIG. 3C is an enlarged view of the nonmetal fibers and the metal fiber.

FIG. 4A is a perspective view of one embodiment of the ZVIF packing in a flat configuration; FIG. 4B is a perspective view of one embodiment of the ZVIF packing in a rolled configuration; FIG. 4C is a top view of one embodiment of the carrier apparatus; FIG. 4D is a side view of one embodiment of the carrier apparatus loaded with bagless inserts of the ZVIF packing; FIG. 4E is a side view of one embodiment of the carrier apparatus; FIG. 4F is a side view of one embodiment of the carrier apparatus loaded with bagless inserts; FIGS. 4G, 4I, and 4K are perspective views of alternative embodiments of the bagless inserts; FIGS. 4H, 4J, and 4L are phantom views of alternative embodiments of the bagless inserts;

FIG. 5 is a schematic displaying the formation of the metal fiber.

FIG. 6A is a schematic displaying the formation of the ZVIF packing; FIG. 6B is a schematic displaying the formation of the ZVIF packing; FIG. 6C is a schematic displaying the blending step and precard apparatus for forming one embodiment of the ZVIF packing; FIG. 6D is a schematic displaying the carding machine and the lapping apparatus for forming one embodiment of the ZVIF packing; FIG. 6E is a schematic displaying the needle punching machine for forming one embodiment of the ZVIF packing; FIG. 6F is a schematic displaying the heat fusing step for forming one embodiment of the ZVIF packing; FIG. 6G is a perspective view of one embodiment of the reeler for forming one embodiment of the ZVIF packing; FIG. 6H is a schematic of one embodiment of the needle punching apparatus; and FIGS. 6I and 6J are side schematic views of one embodiment of the reeler for forming one embodiment of the ZVIF packing

FIG. 7A is a top view of a schematic of one embodiment; FIG. 7B is a top view of a schematic of another embodiment; FIG. 7C a side view of one embodiment of the treatment cell; FIG. 7D is a side view of another embodiment of the treatment cell; FIG. 7E is a perspective view of the treatment cell with the plurality of porous bag layers; and FIG. 7F is a perspective view of the porous bag layer; FIG. 7G. is a cross sectional side view of another embodiment of the treatment cell including a gas line; FIG. 7H. is a cross sectional side view of another embodiment of the treatment cell including a gas line; FIG. 71 is a cross sectional side view of another embodiment of the treatment cell including three gas lines; FIG. 7J is a top cross-sectional view of the treatment cell showing the gas line and the spacer; and FIG. 7K is a perspective view of a pH control system in accordance with one embodiment; FIG. 7L is a schematic side view of one embodiment of the carrier apparatus; FIG. 7M is a schematic side view of one embodiment of the treatment cell; FIG. 7N is a schematic top view of one embodiment of the ZVIF packing configuration; FIG. 7O, is a schematic top view of the helical ZVIF packing configuration; FIG. 7P is a top view of a water distribution array; FIG. 7Q is a side schematic view of the water distribution array; FIG. 7R is a side view of water flow pattern through the water treatment tank; and FIG. 7S is a side view of multiple inserts in the water treatment tank.

FIG. 8 is a plot of the selenium concentrations entering and leaving the treatment cell over the course of the field test.

FIG. 9 is a plot of the fraction of initial Se removed as a function of residence time.

FIG. 10 is a plot of the iron removed as a function of the treatment time.

FIG. 11 is a plot of the pH of the system showing influent and effluent.

FIG. 12 is a plot of the manganese released from the bed over treatment duration.

FIG. 13 is a plot of the selenium removal versus the temperature profile.

FIG. 14 is a treatment cell in a field test.

FIG. 15 is a treatment cell in a field test.

FIG. 16 is a treatment cell after 6 weeks of use.

FIG. 17 is a perspective view of the bench scale water treatment system.

FIG. 18 is a vertical view of the treatment system showing the container, pump and outlet.

FIG. 19 is a perspective view of the ZVIF packing after the bench scale experiment.

FIG. 20 is a plot of the initial Se removal portion fit to an exponential curve for 0-6 hrs.

FIG. 21 is a plot of the selenium removal for 6-12 hours showing linear removal rates.

### DETAILED DESCRIPTION OF THE PREFERRED EMBODIMENTS

The apparatus and process can be understood more readily by reference to the following detailed description of the apparatus and process and the Examples included therein and to the Figures and their previous and following description. While particular reference is made to the removal of selenium, it is to be understood that the elemental removal process and apparatus may be applied to other elements, as described below.

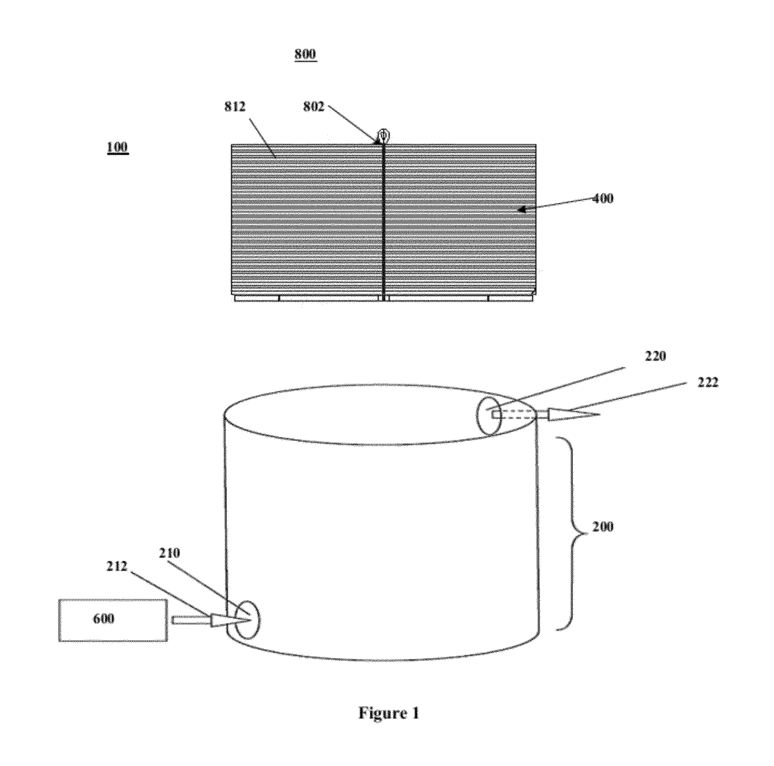

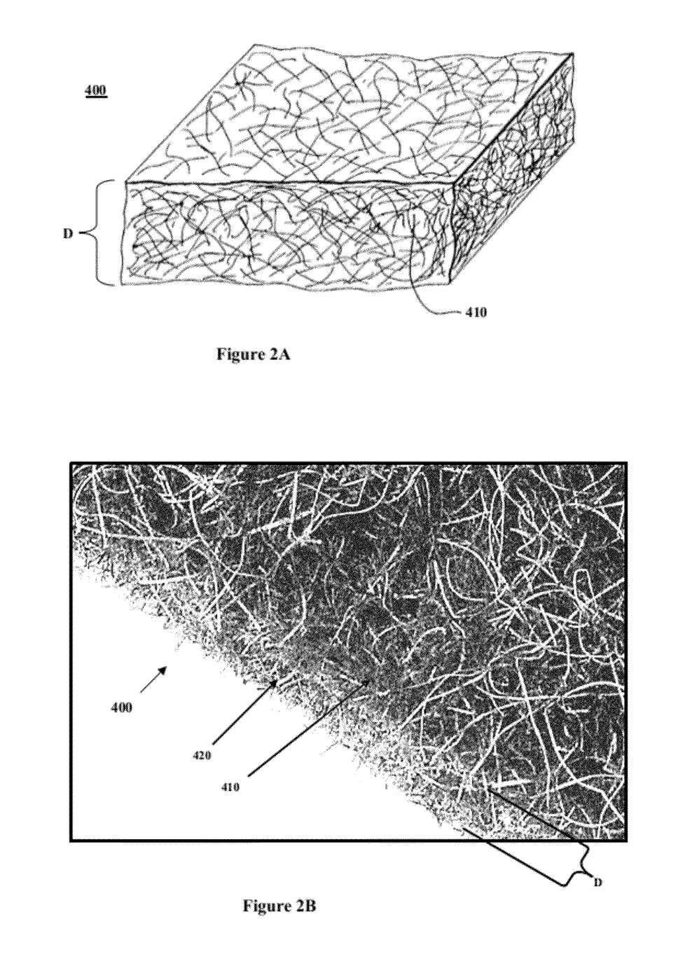

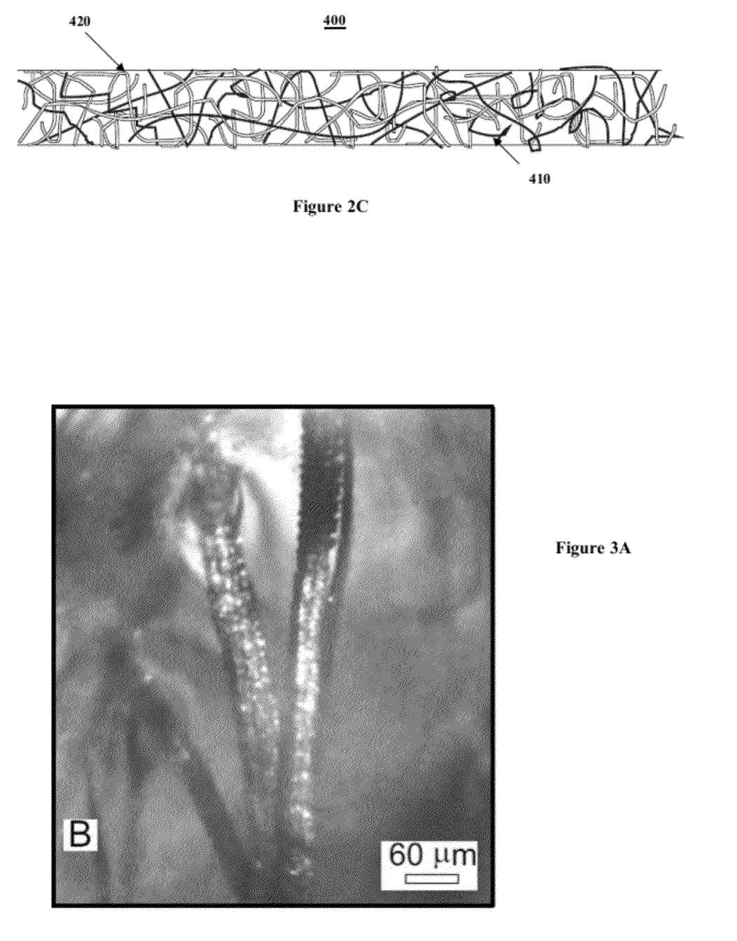

Generally speaking, one embodiment of the element removal process and apparatus is shown in FIG. 1. As shown in FIG. 1, a water treatment cell 100 comprises a container vessel 200, and a carrier apparatus 800 including a plurality of Zero Valent Iron Fiber (“ZVIF”) packings 400 within the carrier apparatus 800. A cross-section of the alternative ZVIF packings 400 are shown in FIGS. 2A-2C and the ZVIF packings 400 comprise a plurality of metal fibers 410 with a density D. The metal fibers 410 comprise an average cross-sectional diameter d. The ZVIF packings 400 include a number of different configurations, as further explained below, which react with elements in the fluid flow throughout the container vessel and remove such elements from the fluid, such as contaminants. The container vessel 200 includes an inlet port 210 and an outlet port 220. In one embodiment, the inlet port 210 may be located at the bottom of the container vessel 200 and the outlet port 220 may be located at the top of the container vessel 200 for bottom-in/top-out fluid flow. In another embodiment, the inlet port 210 may be located at the top of the container vessel 200, and the outlet port 220 may be located at the bottom of the container vessel 200 for top-in/bottom-out fluid flow. Fluid flow is demonstrated by arrows 212 and 222, whereby a water source containing elements requiring removal enters by way of 212 and exits the treatment cell 100 by way of 222. Alternative treatment cells 100 and configurations are discussed below.

In one embodiment, the carrier apparatus 800 comprises a plurality of bagless inserts 812 and a central rod 802, as shown in FIG. 1. The plurality of bagless inserts 812 include the ZVIF packings 400 in a particular configuration. The central rod 802 may be used to place the carrier apparatus 800 into the container vessel 200 or tank. The carrier apparatus 800 may be any shape, shaped in a triangular configuration, circular configuration, elliptical configuration, rectangular configuration, polygonal configuration, trapezoidal configuration, pentagonal configuration, hexagonal configuration, and the like. The carrier apparatus 800 may include alternative ZVIF packing configurations, as further explained below.

In one embodiment, one or more pumps (not shown) may be utilized to facilitate flow through inlet port 210 or outlet port 220, as shown in FIG. 1. Additionally, sieve filters (not shown) may be placed on the inlet port 210 or outlet port 220 to retain solid materials that may plug the medium at the inflow or remove solid reaction products at the outlet port 220. The solid material may include debris, scavenging material, and/or compost that may interact or clog the treatment cell 100. Valves may be located on the inlet port 210 and/or the outlet port 220 to control the flow rate of contaminated water into the treatment cell 100. A top-in/bottom-out fluid flow may include a pipe drain that rises up the side of the tank to below the inlet port 210, such that the container vessel 200 only drains after being filled with contaminated water. The inlet port 210 flow rate may be set to control the residence time. An oxygen trap 600 may be included to remove atmospheric oxygen before the contaminated water enters the treatment cell 100 and at the air/solid interface of the metal fiber 400. The oxygen trap 600 comprises of a replaceable iron cartridge or some commercially available device to reduce the amount of oxygen entering the inlet port 210 or at the air/metal fiber 410 interface.

In operation, contaminated water flows into the treatment cell 100 through inlet port 210, where the contaminated water flows through ZVIF packings 400, which may be the bagless inserts 812 or the porous bag wall material 320 further described below, and contaminants are removed through an interaction with the fill 340 of the ZVIF packing 400. The residence time is the time the contaminated water interacts with the ZVIF packing within the treatment cell 100. The residence time can be roughly determined by calculating the volume in gallons of ZVIF packing 400, and then determining the time it would take to displace that volume at a particular flow rate. The shortest residence times is determined by the permeability of the medium, or fill material 340 for gravity-flow systems if water flow and delivery pressure are held constant. At some flow, water will not penetrate the medium efficiently and water will overflow the vessel 200 for top-in/bottom-out flow, or physically push the medium upward by water pressure for bottom-in/top-out fluid flow. The upper limit on the residence time depends on the lowest possible flow available to the vessel 200. Alternatively, the water supplied via pump to the inlet port to apply pressure for the water flow and contaminated water to flow through the ZVIF packings.

In one embodiment, contaminated water containing selenium as selenite or selenate contacts the ZVIF packing 400 begins to remove selenium by reduction of selenate and selenite with Fe(0) (which is elemental or zero-valent iron “ZVI”), as shown by the following equations:

SeO₄⁻²+Fe(0) Fe(II,III)+Se(0); (1)

SeO₄⁻²+Fe(0) Fe(II,III)+Se(IV); and (2)

SeO₃⁻²+Fe(0) Fe(II,III)+Se(0). (3)

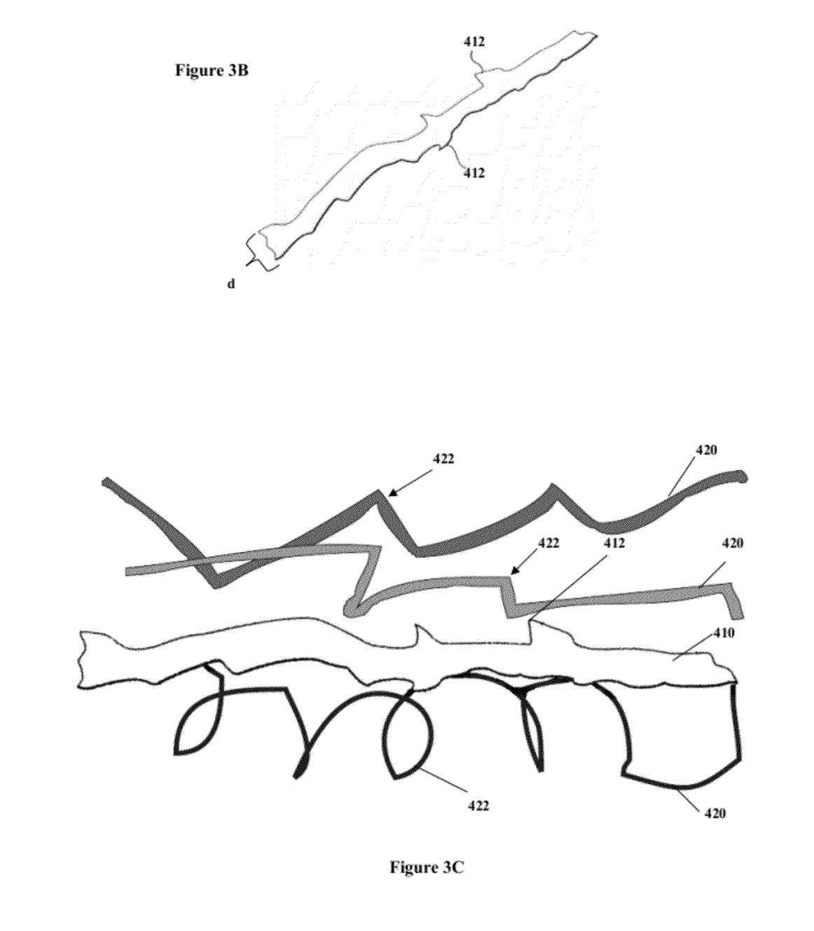

When selenate and selenite react with ZVI Fe(0) oxidizes to Fe(II) or Fe(III) and insoluble Se(0) precipitates out of solution or adsorbs on the iron surface. If selenate is reduced to Se(IV) rather than Se(0), the resultant Se(IV) can adsorb to the iron fibers or is immobilized by Fe(III) oxides that are formed in the reaction. The synchrotron studies found Se(IV) adsorbed on the surface of the iron fiber. Iron serves as an electron source and as a substrate for Se(IV) adsorption. The ZVIF packing 400 reduces selenate to Se(IV) and Se(0) by a direct surface reaction. The reaction products are then immobilized by adherence at the ZVI reaction site or iron reaction products, as shown in FIG. 3A. When the ZVIF packing 400 has completely reacted, the ZVIF packing 400 ceases to remove selenium and must be replaced. Alternatively, replacement needs to take place before all the iron is reacted to Fe(II) and FE(III). Typically a preferential flow path develops and once the iron in the preferential path is oxidized, water bypasses the media and thus no selenium is reacted. The percentage of unreacted zero valent metal or un-oxidized zero-valent metal remaining in the tank will vary from tank to tank and ZVIF packing configurations. The ZVIF packing 400 may be removed from the treatment cell 100 by slowly lifting the lift straps 310 out of the container vessel 200, allowing the water to drain out into the container vessel 200, and removing the porous bag 300 from the container vessel 200. Alternatively, the tanks are drained before the bags are lifted out. If bagless inserts are used, the carriers will remove the bagless inserts. The removed ZVIF packing 400 is replaced with a new porous bag 300 with new ZVIF packing 400 for additional selenium removal. In one embodiment, a suitably designed system using the ZVIF packing 400 effectively removes selenium ions from the neutral or slightly alkaline mine water (pH 6-9) to a concentration below 5 μg/L. A neutral to alkaline pH avoids acid dissolution of iron, and in one embodiment, the pH may be adjusted to a range of pH 6 to a pH 9. Selenium removal reaction kinetics are much faster at lower pH, such that a target pH of raw water may be adjusted to 6.3. Alternatively, selenium removal to below 5 μg/L with pH as high as about 8 may also be employed depending on the pH and chemistry of the raw water.

In one embodiment, other contaminants or low concentration substances in target waters may react with the ZVIF packing 400. For example, Fe(0) may react with one or more of chromium (as chromate), cobalt ions, arsenic (as arsenate or arsenite), cadmium (as Cd⁺²), copper (as Cu⁺²), cyanide, gold, lead, manganese (as permanganate), molybdenum (as molybdate), nickel, nitrate, selenium (as selenate or selenite), technetium (as TcO⁻⁴), tin, uranium (as uranyl), vanadium (as vanadyl or other oxy species), Mercury (Hg), Aluminum (Al) and Copper (Cu) radionuclides, pathogens (viruses, bacteria, protozoa), and/or halogenated organics such as chlorinated organics, and derivatives thereof. Fe(0) may also react with pesticides and herbicides, such that the pesticides and herbicides are adsorbed to the treatment system. As such, the treatment cell 100 serves as an effective clean-up system for mine water or other contaminated water sources to make contaminant removal more controllable.

Additionally, the Fe(II) produced by the reduction of selenium and dissolved oxygen is further oxidized to Fe(III), forming iron oxide and hydroxide minerals, as illustrated by the following equations:

2Fe²⁺+1/2O₂+3H₂O→2FeOOH(s)+4H⁺ (4)

2Fe²⁺+1/2O₂+2H₂O→2Fe₂O₃(s)+4H⁺ (5)

Equation (4) and (5) shows the formation of various oxyhydroxides of iron, which are colloquially known as “rust” that is associated with ZVI oxidation. The porous bag 300 contains most of the rust materials. In one embodiment, when the ZVIF packing 400 has reacted to exhaustion, the porous bag 300 will contain mostly rust and entrained selenium. Fe(III) is trapped in the ZVIF packing media regardless of using a porous bag or bagless insert. Fe(III) in the anoxic effluent is not trapped in the media, but can be reclaimed by Iron filters. Clogging is prevented by the formation of small oxyhydroxide particles and sufficient fluid flow to purge them, as further detailed below in the Water Delivery Systems. In one embodiment, ferrihydrite and goethite may be the first minerals formed.

Alternatively, in one embodiment, the ZVIF packing 400 comprises an interengaged mixture of a plurality of metal fibers 410 and a plurality of nonmetal fibers 420, as shown in FIG. 2C. The metal fibers 410 and nonmetal fibers 420 and the ZVIF packing 400 can be configured in alternative configurations, as further detailed below. The metal fibers 410 and nonmetal fibers 420 are interengaged and intertwined to provide for a density and resiliency. The increased resiliency and durability is provided for by the interengagement of the metal and nonmetal fibers. Resiliency can be radial resiliency or the ability of the ZVIF packing to return to its original shape after compressing, bending, or deformation when the ZVIF packing is placed into a carrier apparatus or when the carrier apparatus is being placed into the tank.

In one embodiment, the ZVIF packing 400 includes metal fibers 410 and polyester fibers 420, as shown in FIG. 3A. The ratio of metal fibers to nonmetal fibers may be by weight, where the ZVIF packing 400 has a total density of metal fibers based upon the ratio of metal fibers to nonmetal fibers. In one embodiment, the ZVIF packing 400 is needle punched to thickness D to interengage the metal fibers and nonmetal fibers. In another example, the needle punched ZVIF packing is heat activated by the heat fusing step to give the ZVIF packing a decreased thickness, as further explained below.

Alternatively, the ZVIF packing 400 includes only a plurality of metal fibers 410, as shown in FIG. 3B. Generally speaking, the metal fibers 410 include an average cross-sectional diameter d, as shown in FIG. 3B. The metal fibers 410 comprise an average cross-sectional diameter d ranging between about 10 and 125 microns. A superfine metal fiber includes an average cross-sectional diameter d of 25 microns. An extra fine metal fiber includes an average cross-sectional diameter d of 35 microns. A very fine metal fiber includes an average cross-sectional diameter d of 40 microns. A fine metal fiber includes an average cross-sectional diameter d of 50 microns. A medium metal fiber includes an average cross-sectional diameter d of 60 microns. A medium coarse metal fiber includes an average cross-sectional diameter d of 75 microns. A coarse metal fiber includes an average cross-sectional diameter d of 90 microns. An extra coarse metal fiber includes an average cross-sectional diameter d of 100 microns. In one embodiment, the selection of the average cross-sectional diameter d may be dependent on various factors including, but not limited to, concentrations of substances or contaminants of interest, the removal kinetics, and the flow characteristics of various fiber densities, and the like. Alternatively, the average cross-sectional diameter d may include an average fiber width between 10 to 1000 microns.

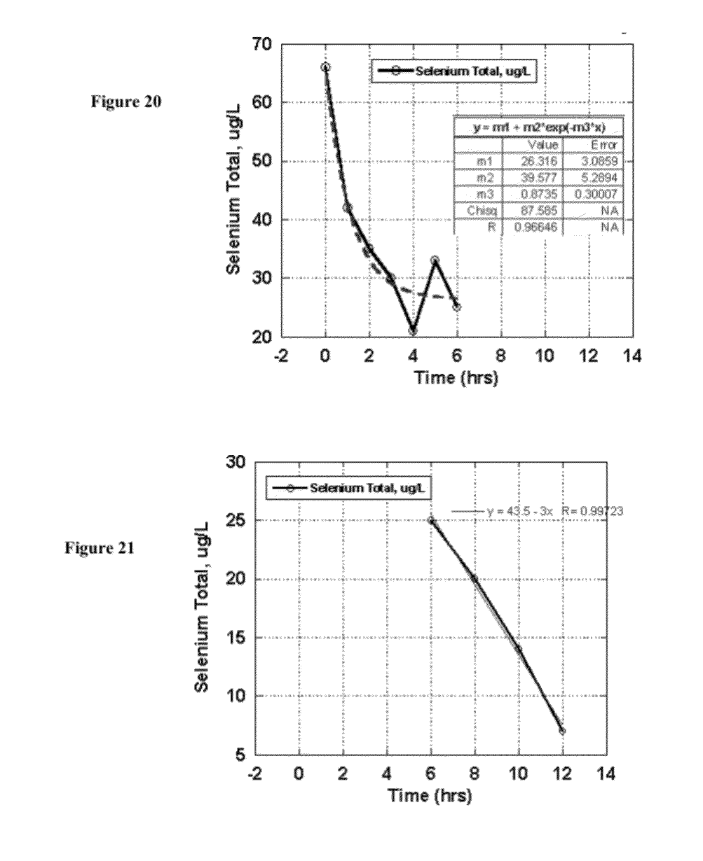

As shown in FIG. 3B, in one embodiment, the ZVI fibers include an irregular cross-section and rough outer surfaces with projections 412 and fissures formed along the outer surfaces. The irregular cross-sections vary continuously along the length of the resulting fibers to provide generally asymmetrical metal fibers in the longitudinal and horizontal direction. The nature of the metal fibers provides increased surface area of the metal fiber for interaction with selenium ions. In one embodiment, the projections 412 are polycrystalline iron oxides. The increased surface area of the metal fibers increases the rate of reduction of selenium ions for the treatment system and allows for increased removal of selenium, i.e. providing a substrate for the reduction of soluble selenium species to insoluble Se(0) which is retained by surface adhesion or by the irregular cross sections. Selenate can also be reduced and deposited onto the metal fiber 410 surfaces as selenite. The surface area of the metal fibers 410 in the treatment cell 100 is one factor that determines the rate of selenium reduction. The rate of selenium reduction may be given, most generally, by the formula −d[SeO₄⁻²]/dt=k[SeO₄⁻²]ⁿ. Where k is a rate constant and n is the reaction order. The increased surface area of the metal fiber 400 functionally increases k because the more reactive collisions with the surface area are possible. For a given surface area, the selenium removal has been shown to be first order (n=1) at short reaction times with indications of zero order rate for long reaction times and very low concentrations. Other ions, such as chromate, have first order removal kinetics as well. In one embodiment, high selenium concentrations and the number of collisions with the metal fiber 400 depends on how many selenate molecules are available for collision (first order). As the concentration of selenate falls, the number of collisions with the metal fiber 400 depends on finding fiber, which is zero order in selenate. As shown in FIG. 20, an exponential curve is fitted to the initial selenium removal for 0-6 hours and shows first order removal for the reaction rate. As shown in FIG. 21, selenium removal at later times of 6-12 hours and shows zero order removal for the reaction rate. And the greater fiber densities favor kinetics that is in the first order for selenate to lower selenate concentrations. In one embodiment, metal fiber densities from 0.5 volume % to 2 volume % remove selenium at favorable rates.

ZVIF Packings

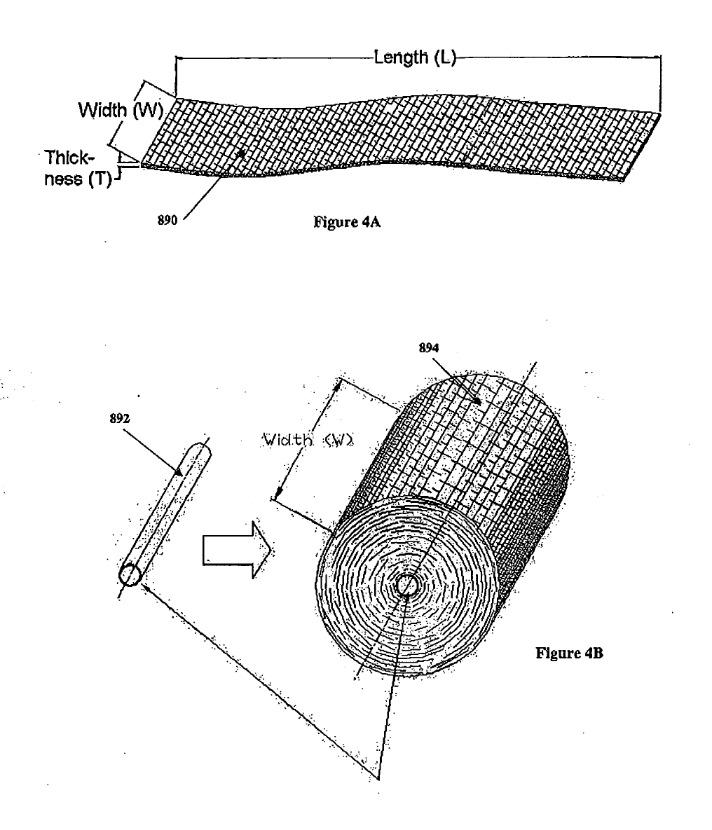

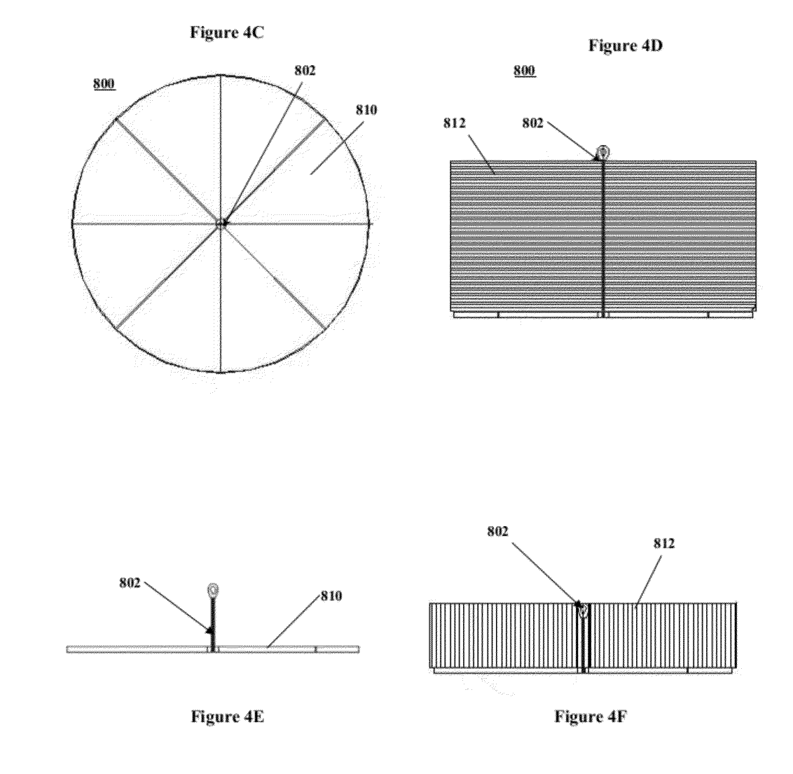

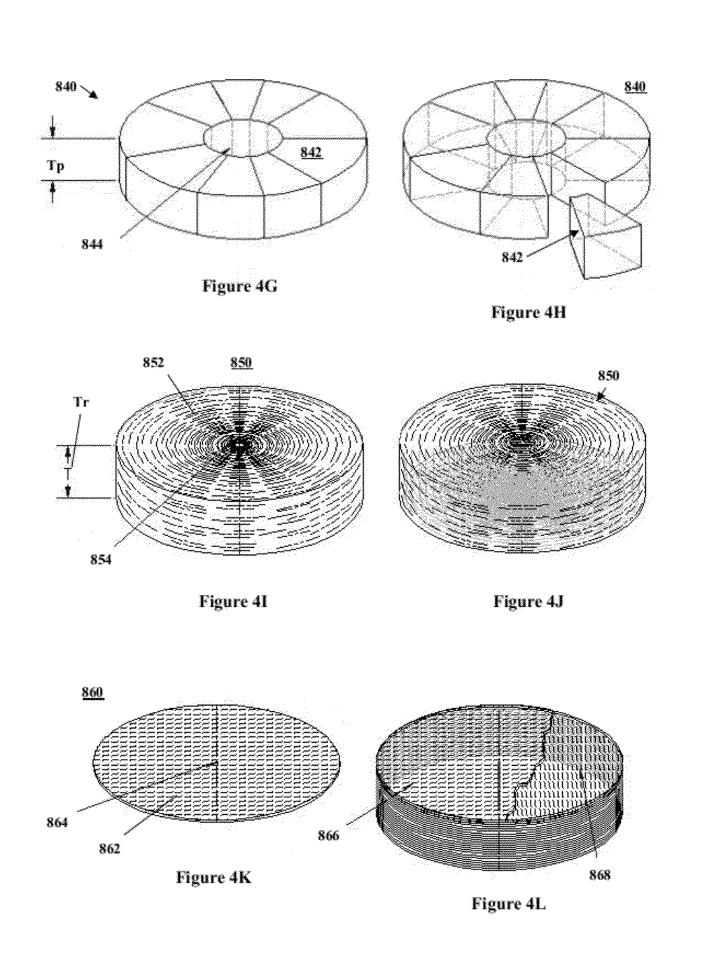

The ZVIF packings 400 may include different configurations to optimize elemental removal and fluid flow through the treatment cell 100. One configuration for the ZVIF packings 400 is a fabric media 890, as shown in FIG. 4A. The fabric media 890 includes a length L, a width W, and a thickness T. The fabric media 890 is generally shown as a rectangular three-dimensional configuration in FIG. 4A; however, the fabric media 890 may assume alternative three-dimensional configuration, such as triangular configuration, circular configuration, elliptical configuration, rectangular configuration, polygonal configuration, trapezoidal configuration, pentagonal configuration, hexagonal configuration, and the like. The fabric media 890 may include the plurality of metal fibers 410 interengaged with the plurality of nonmetal fibers 420. The fabric media 890 may include varied sections of metal fiber density or ratio of metal fibers to nonmetal fibers along the length L or width W of the fabric media 890. In one embodiment, the metal fiber ratio to nonmetal fibers is 1:0 along at least a portion of the length of the fabric media 890, 9:1 along at least a portion of the length of the fabric media 890, 8:1 along at least a portion of the length of the fabric media 890, 7:1 along at least a portion of the length of the fabric media 890, 6:1 along at least a portion of the length of the fabric media 890, 5:1 along at least a portion of the length of the fabric media 890, 4:1 along at least a portion of the length of the fabric media 890, 3:1 along at least a portion of the length of the fabric media 890, 2:1 along at least a portion of the length of the fabric media 890, or 1:1 along at least a portion of the length of the fabric media 890. Also, the fabric media 890 includes a tension along the length L and width W. In one embodiment, the tension may be altered along the length L and/or width W used in the rolling process determines the overall density of the fabric media 890. The nonmetal fibers include a non-reactivity in water, and the nonmetal fibers provide additional structural integrity for the fabric media as the metal fibers oxidize and break down upon interaction with fluid flow. The structure of the fabric media 890 minimizes the occurrences of preferential flow patterns and gives a more even flow of water through the insert which extends the life of the fabric media 890.

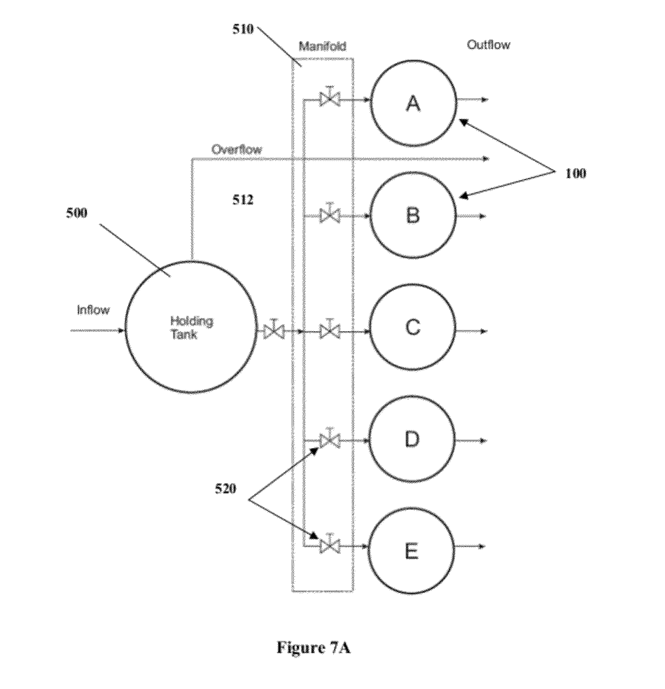

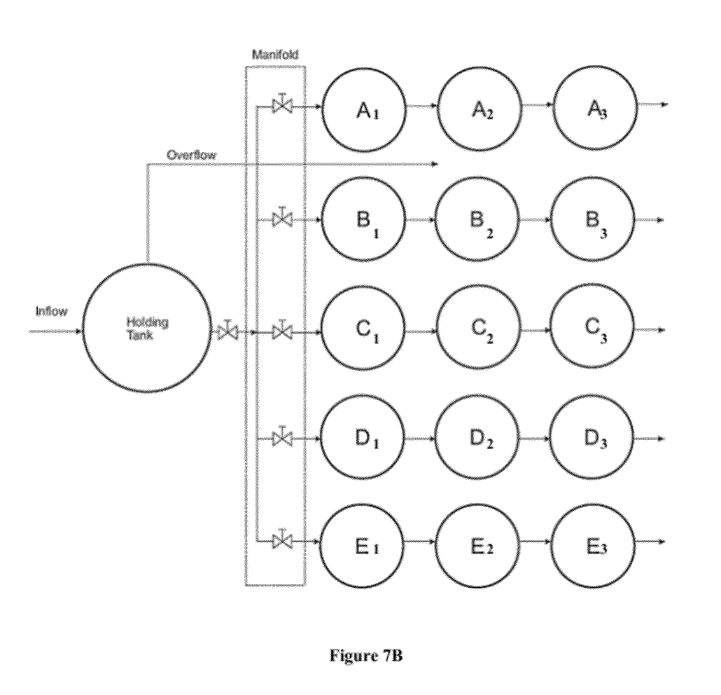

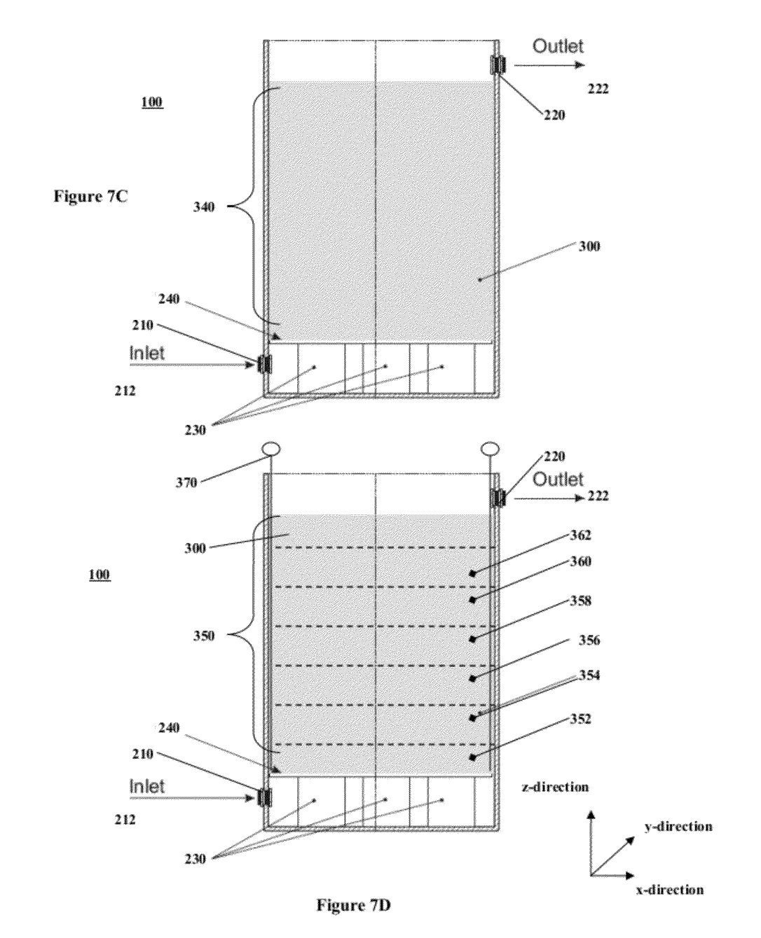

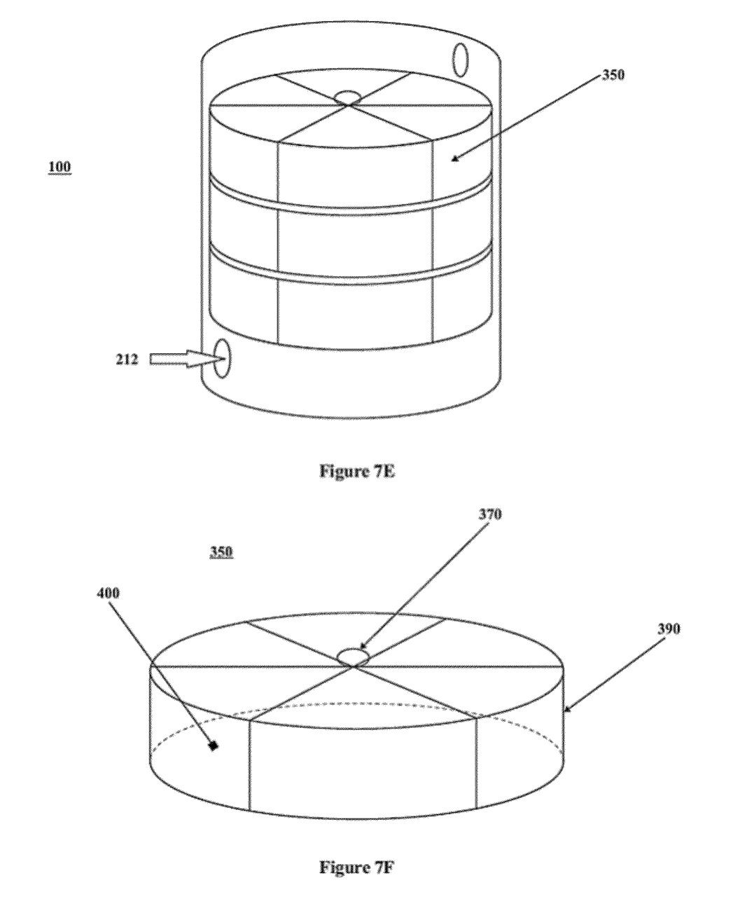

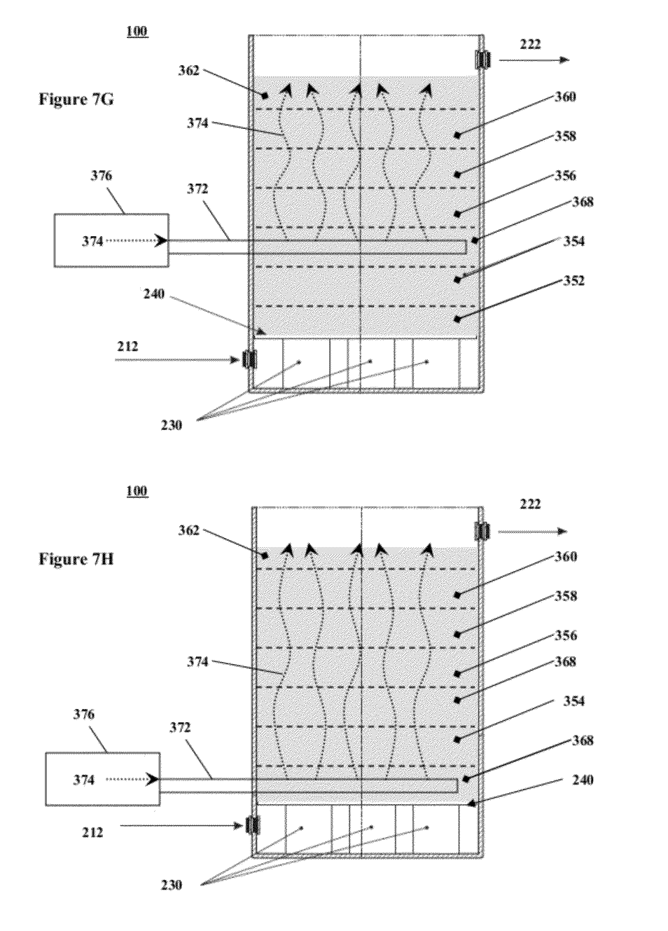

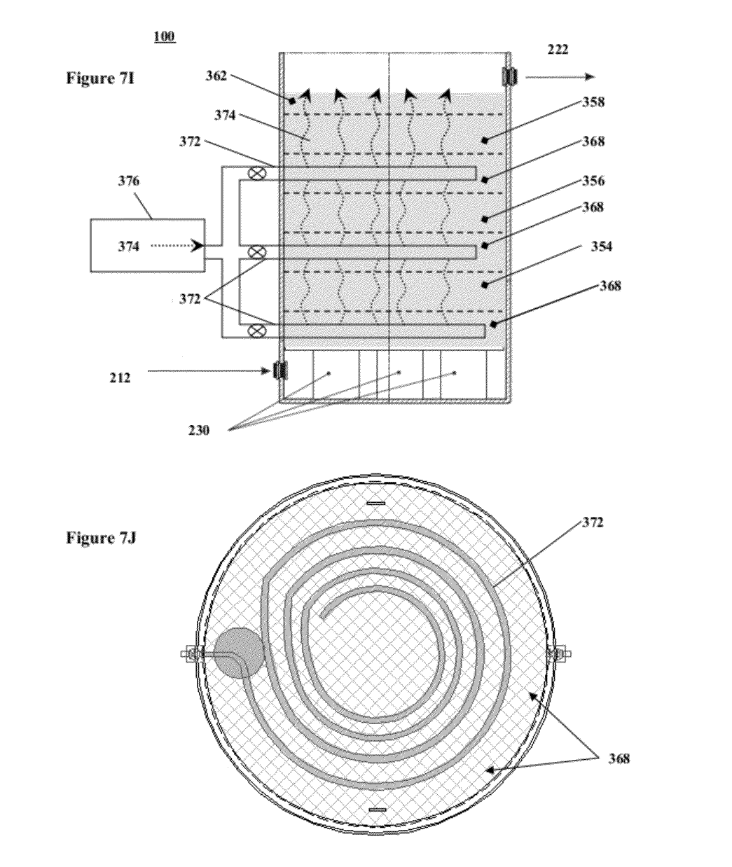

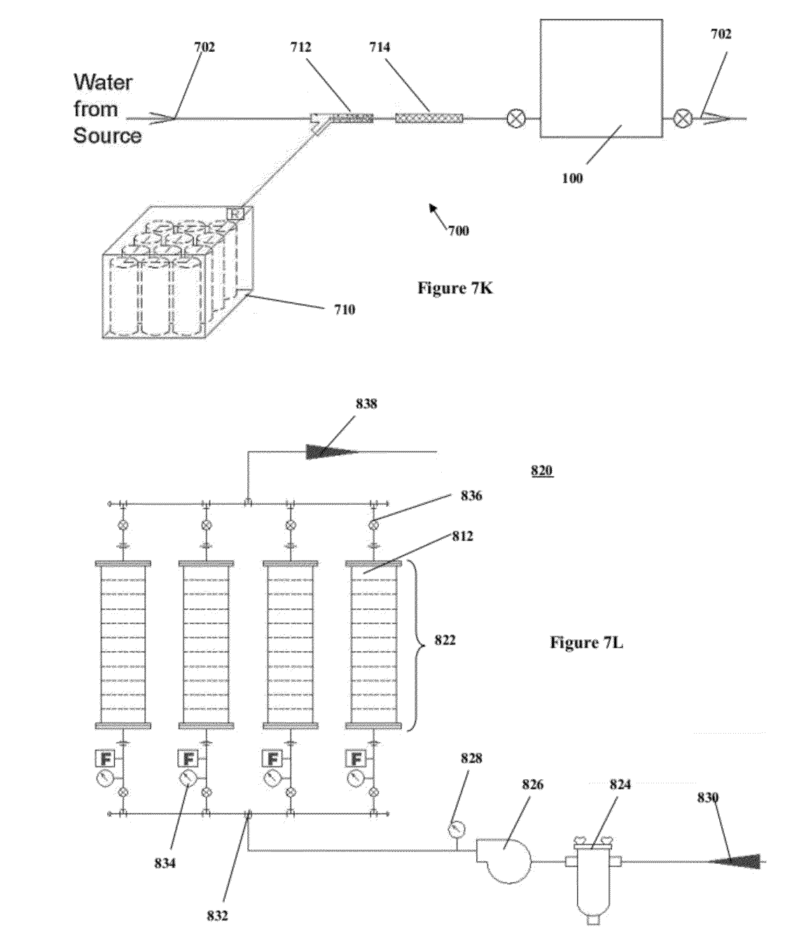

The fabric media 890 may be placed directly into the container vessel 200, or the fabric media 890 may be processed to a helical configuration 894, as shown in FIG. 4B. The helical configuration 894 may be placed into the container vessel 200. In one embodiment, the fabric media 890 is rolled about an inner core 892 that includes a hollow center throughout the longitudinal axis of the helical configuration 894. When the fabric media 890 is rolled into the helical configuration 894, the tension may be altered along the longitudinal direction according to the tightness of the helical pitch that the fabric media 890 is rolled about the inner core 892. When the fabric media 890 is rolled into a helical configuration 894 with alternative ratios along the length L of the fabric media 890, the result is varied densities along the helical configuration 894, as shown in FIG. 7N. In one embodiment, the helical configuration 894 includes three different zones of density of metal fibers and nonmetal fibers. In one embodiment, there is an outer zone 895, a middle zone 896, and an inner zone 897, whereby the outer zone 895 includes a higher density of metal fibers than the middle zone 896, and the middle zone 896 includes a higher density of metal fibers than the inner zone 897. Alternatively, the inner zone 897 may include a higher density than the middle zone 896, and the middle zone 896 includes a higher density of metal fibers than the outer zone 895. In one embodiment, the outer zone 895 includes a density of metal fibers to nonmetal fibers of at least about 10:0, 9:1, 8:1, 7:1, or 6:1. In one embodiment, the middle zone includes a density of metal fibers to nonmetal fibers of at least about 10:0, 9:1, 8:1, 7:1, 6:1, 5:1, 4:1, 3:1, or 2:1. In one embodiment, the inner zone 897 includes a density of metal fibers to nonmetal fibers of at least about 7:1, 6:1, 5:1, 4:1, 3:1, 2:1, or 1:1. Alternatively, the middle zone 896 may include a greater thickness Tₘ when in the helical configuration 894 in comparison to the thickness Tₒ of the outer zone 895 and the inner zone 897 may include a greater thickness Tᵢ in comparison to the thickness Tₘ of the middle zone 896. The ratio or density of the metal fibers to the nonmetal fiber along with the needle punching of the material plus the tension used in the rolling process determines the overall density of the fabric media to provide for a uniform fabric media with the inner zone of preferential flow in comparison to the outside perimeter of the fabric media 894.

Alternatively, as shown in FIG. 7O, the helical configuration 894 may include a first zone 898a, a second zone 898b, a third zone 898c, and a fourth zone 898d. The first zone, second zone, third zone, and fourth zone may have alternative densities or ratios of the metal fiber to the nonmetal fiber to provide for preferential flow and elemental removal for the helical configuration.

In another embodiment, the carrier apparatus 800 comprises a plurality of bagless insert sections 810 for the ZVIF packings 400 and a central rod 802, as shown in FIGS. 4C-4D. In one embodiment, the bagless insert 812 sits on top of the carrier 800. The central rod 802 may be used to carry the carrier apparatus 802 to and from a treatment cell or tank 200. The carrier apparatus 800 may be any shape, shaped in a triangular configuration, circular configuration, elliptical configuration, rectangular configuration, polygonal configuration, trapezoidal configuration, pentagonal configuration, hexagonal configuration, and the like. The bagless insert sections 810 may be preformed sections or areas of where a plurality of bagless inserts 812 may be loaded, as shown in FIGS. 4C-4D. The bagless inserts 812 may be loaded on top of one another or placed adjacent to each other, whereby the bagless inserts may also be unloaded form the carrier apparatus 800. The bagless inserts 812 include a ZVIF packing 400 of any particular density and geometric configuration, as described herein. In one embodiment, the bagless inserts 812 conform to the size and configuration of the bagless insert sections 810. Alternatively, the bagless inserts 812 include a stand-alone size and configuration. As such, the bagless inserts 810 may be any shape, shaped in a triangular configuration, circular configuration, elliptical configuration, rectangular configuration, polygonal configuration, trapezoidal configuration, pentagonal configuration, hexagonal configuration, and the like. The bagless inserts 810 are shown in a vertical reel media insert in FIG. 4F and a disc insert media configuration in FIG. 4D, or alternative configurations as detailed below. The bagless inserts 810 eliminate the need for bags and straps to prevent preferential water flow and accelerated insert degradation. The carrier apparatuses or treatment tanks described herein can be used with both reeled inserts and fabric disc inserts, or any other inserts as further detailed herewith. Alternatively, multiple carrier apparatuses may be used in a single treatment cell, i.e. the carrier apparatuses are placed on top of each other or in an adjacent fashion.

Alternatively, the ZVIF packings 400 may assume a bagless insert 812 configurations. Bagless insert section 810 may be preformed sections or areas of the container vessel 200 or the carrier apparatus 800 where a plurality of bagless inserts 812 may be loaded, as shown in FIGS. 4D and 4F. The bagless inserts 812 may be loaded on top of one another or placed adjacent to each other, whereby the bagless inserts may also be unloaded form the carrier apparatus 800. The bagless inserts 812 include a ZVIF packing 400 of any particular density and geometric configuration, as described herein. In one embodiment, the bagless inserts 812 conform to the size and configuration of the bagless insert sections 810. Alternatively, the bagless inserts 812 include a stand-alone size and configuration. As such, the bagless inserts 810 may be any shape, shaped in a triangular configuration, circular configuration, elliptical configuration, rectangular configuration, polygonal configuration, trapezoidal configuration, pentagonal configuration, hexagonal configuration, and the like. The bagless inserts 810 are shown in a vertical reel media insert in FIG. 4F and a disc insert media configuration in FIG. 4D, or alternative configurations as detailed below. The bagless inserts 810 eliminate the need for bags and straps to prevent preferential water flow and accelerated insert degradation. The carrier apparatuses or treatment tanks described herein can be used with both reeled inserts and fabric disc inserts, or any other inserts as further detailed herewith. Alternatively, multiple carrier apparatuses may be used in a single treatment cell, i.e. the carrier apparatuses are placed on top of each other or in an adjacent fashion.

In one embodiment, the ZVIF packings 400 may be configured into the bagless media insert 812 as described above. One type of bagless media insert is a pie-piece insert 840, as shown in FIGS. 4G-4H, and described previously. The pie-piece insert 840 includes a plurality of pie-pieces 842 that fit together with adjacent pie-pieces 842 to form complete polygonal or circular structure that fits within the treatment tank. Alternatively, the pie-pieces 842 may form a discontinuous polygonal or circular structure, as shown in FIG. 4H. Preferably, the pie-pieces 842 form a central lumen 844 such as to fit a central core or stability core that prevents the pie-pieces from moving during the inflow of water or fluid. Alternatively, the central lumen 844 is also made from metal or steel and may a part of the media. The pie-pieces 842 themselves may be any circular, polygonal shape, and any number of pie-pieces 842 may make up or form the complete pie-piece insert 840. In one embodiment, four to six pie-pieces 842 are used in one treatment tank, alternatively, between about 2-20 pie pieces 842 may be used, alternatively, between about 5-10 pie pieces may be used depending on the desired flow rate and contaminant removal required. The pie-piece insert 840 includes a thickness (Tp), which may approximate the height or width of the treatment tank. The pie-piece inserts 840 are made by compressing ZVIF layered structure segments in fixed shaped cavities using a press. The densities of the segments are controlled by the amount of ZVIF in the cavities along with the stroke of the press. The press's stroke also controls the segment's thickness. The segments are then assembled inside the open mesh fabric bags inside a larger fixture that has the same shape as the finished bagless insert.

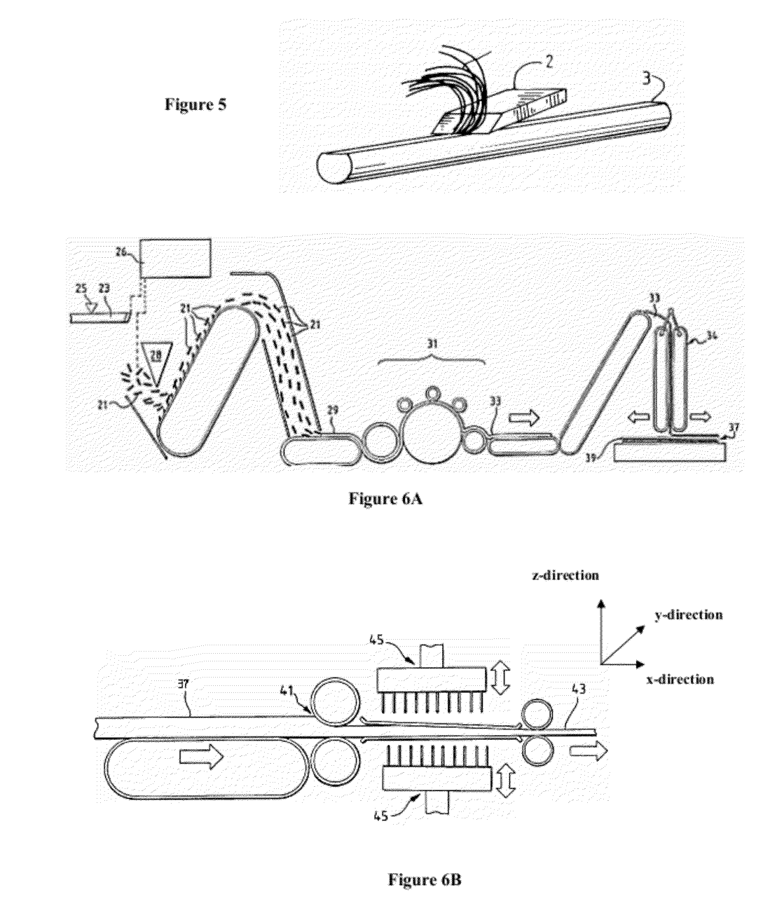

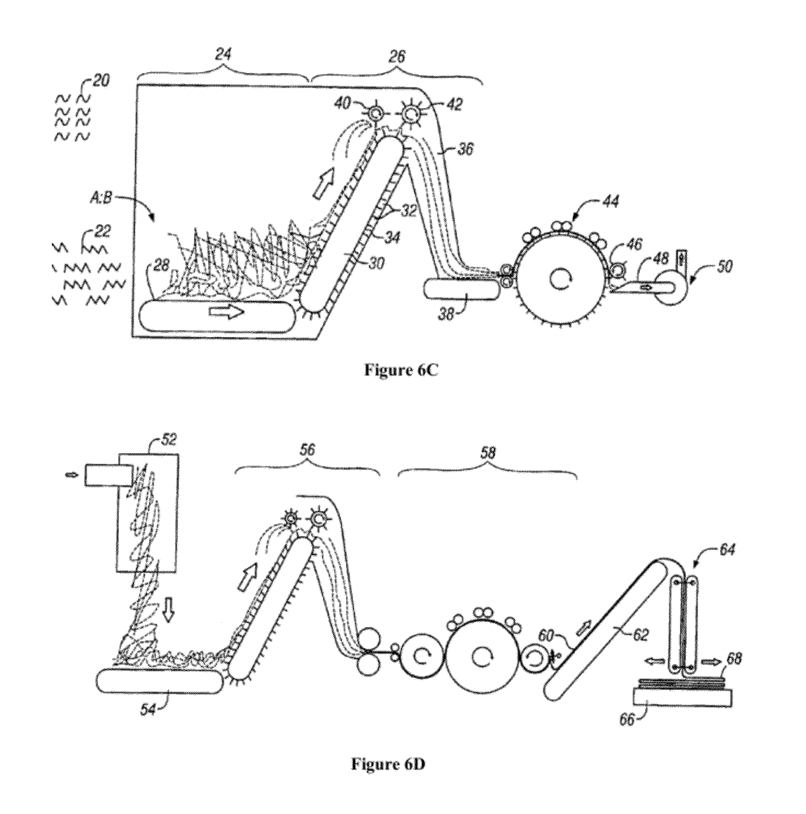

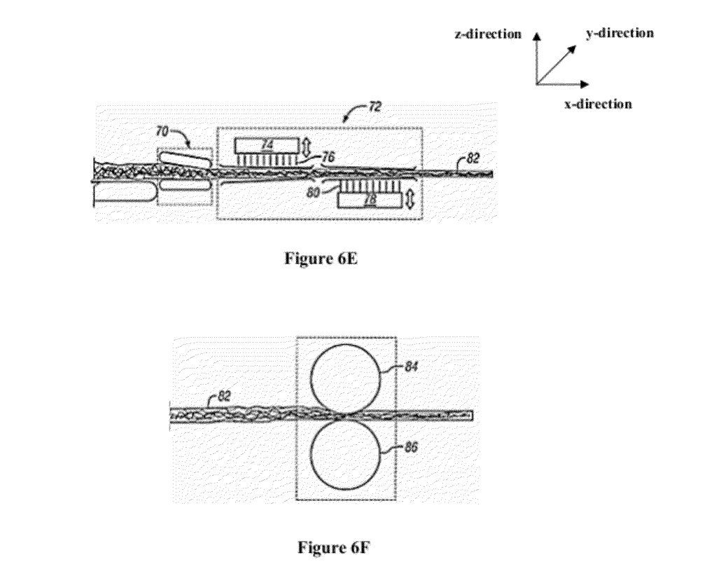

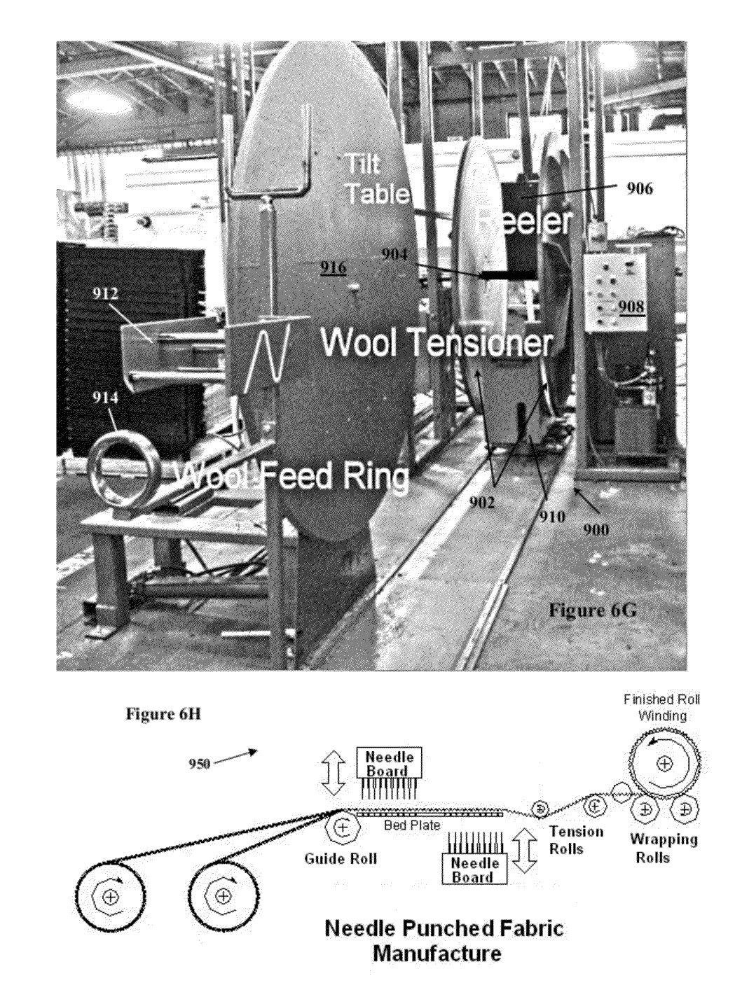

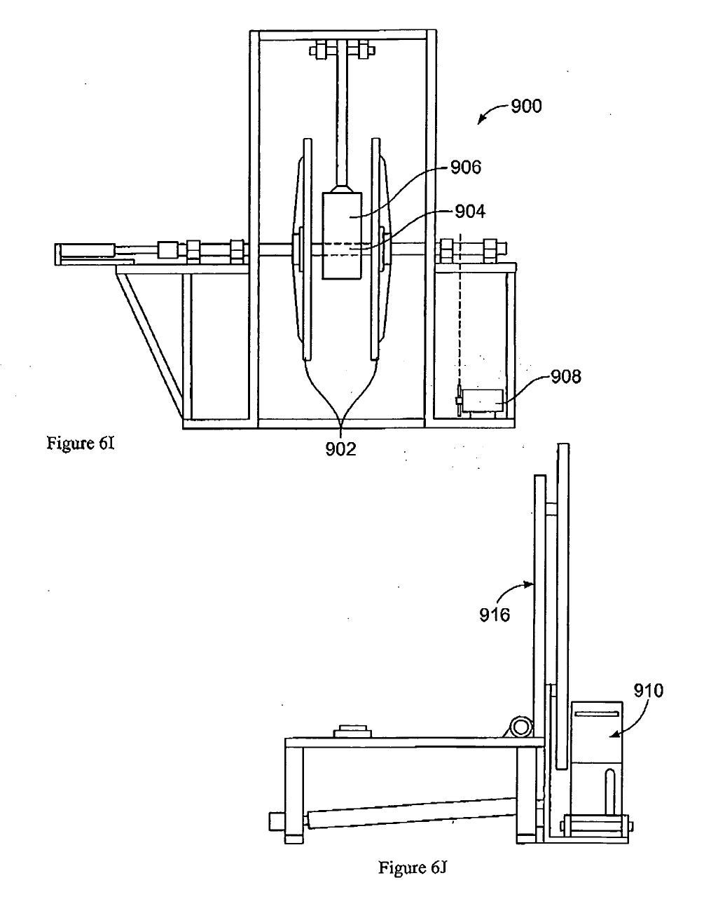

A second type of bagless media insert 812 is a reeled insert 850, as shown in FIGS. 4I-4J. The reeled insert 850 includes a continuous ribbon 852 of the ZVI fiber or ZVIF packing In this embodiment, continuous ribbons of ZVIF packings 400 are wound around a rotating hollow core 854. Alternatively, the reeled insert includes a non-continuous ribbon 852 of the ZVI fiber, whereby non-continuous ribbons 852 overlap and interengage with adjacent non-continuous ribbons 852. The reeled insert include a thickness (Tr) of the reeled insert is several times the width of the continuous ribbon 852, where the continuous ribbon 852 is evenly traversed back and forth as the reel is wound until the specified outer diameter is reached. The outer diameter may be between 0 to 50 feet, alternatively, between about 5 to 40 feet, alternatively, between about 10-30 feet. The reeled insert 850 density is mainly controlled by a tensioner 912 and reeling speed, as shown in FIGS. 6I-6J and 6G. The design of the reeler 900 is based on the same type of technology as smaller reelers, but has several differences including the way the reels are handled and how their tension is controlled. The reeler 900 is operably coupled to a reel truck 910 and the reeler 900 generally includes a central core 904 operably coupled to a motor 908 to spin or rotate about a horizontal axis with opposing circular faces 902 about the central core 904. The reel truck 910 moves the reel to a tilt table 916 after reeling. Tension control may be accomplished by several ways. In one embodiment, the folded ZVI fibers are fed from a box, over and under polished bars on the tensioner 912 (as shown in FIG. 6G). The tension is based on the ZVI fiber's tortuous path and the speed at which it is drawn from the box and the ZVI fed ring 914, which increases as the insert's diameter increases. In an alternative embodiment, a weighted paddle 906 is nearly vertical when the reel's diameter is small, and as the reel diameter grows, the paddle's 906 weight has more impact as it pivots more towards horizontal. This provides more tension uniformity as the reel diameter grows. After the appropriate reel and tension has been obtained, the tilt table 916 orients the reel horizontal from the vertical position so that it may be hoisted or moved. The reeled inserts 850 may be placed in the same type of open mesh fabric bag as “pie piece” inserts or can be placed in the treatment tanks in specialized carriers without the use of a bag.

A third type of bagless media insert 812 is a metrix disc insert 860, as shown in FIGS. 4K-4L. The metrix disc insert 860 comprises needle punched ZVIF roll fabric 862 or metrix, which is cut to shape. The metrix disc insert 860 is shown in a circular configuration; however, the metrix disc insert 860 may include any configuration, such as a polygonal, rectangular, trapezoidal, hexagonal, and the like. The ZVIF roll fabric 862 can be made by a needle punching machine 950, as shown in FIG. 6H. The needle punching machine includes width capacity, which accommodates the diameter of the metrix disc insert 860 that needs to be smaller than the machine's width capacity. The density of the metrix disc insert 860 is controlled by the number of rolls of the ZVIF multi-layer structure 37. The thickness (Tm) of the metrix disc insert 860 is controlled by the number of needle punches per unit area of the fabric roll. Multiple discs are then stacked on a specialized media carrier without the need for an open mesh fabric bag. Since fibers in each disc are basically isotropic, each metrix disc insert 860 is stacked with it's fibers perpendicular to the adjacent metrix disc insert 860, whereby one metrix disc insert 860 includes fibers oriented in the X-direction and Z direction, due to the needlepunching 866 and an adjacent metrix disc insert 860 includes fibers oriented in the Y-direction and Z direction 868; thus ensuring the most uniform flow through the bed of media. The metrix disc inserts 860 are then placed in the carrier apparatus and then the carrier apparatus is placed in a treatment tank.

Efficient removal of selenium from aqueous solution using ZVIF packings depends on many parameters, one of which is optimal water flow through the media. Optimal water flow through the media utilizes as much of the ZVIF packing's surface area as possible yielding the best chance for aqueous selenium or contaminants to encounter the ZVIF packing and initiate the oxidation-reduction reaction. For optimal water flow, uniformity of the ZVIF packing density within the media as well as snug media fit inside the tank are critical. The pie-piece inserts include a uniformity of the ZVIF density within the media, as well as snug media. Reeled and Metrix fabric inserts have improved density control and fit well within the treatment tank.

Metal Fibers

As shown in FIG. 5, in one embodiment, the metal fibers 400 are produced by shaving a metal wire 1 with a metal member 2 with a succession of serrated blades, as disclosed in commonly assigned U.S. Pat. Nos. 5,972,814 and 6,249,941, which are hereby incorporated by reference. A suitable lubricant, such as oil, is preferably applied to the metal member 2 as it is being shaved by the blades in sufficient quantity so that the metal fibers retain on their outer surface a carding-effective amount of the oil or lubricant. “Carding-effective amount” of oil or lubricant means that the metal fibers, when blended with the nonmetal fibers, can be carded without substantial breakage or disintegration. The lubricant optionally may be applied after the metal fibers are formed. The carding-effective amount of oil generally may be in the range of about 0.3 to 1.0 wt. % oil, more preferably about 0.4 to 0.7 wt. %, based on the total weight of the metal fibers, although lesser or greater amounts may be used depending on the type and average diameter of the metal fibers. Preferably, the metal fibers are made from carbon steel, to result in Zero Valent Iron. However, the metal fibers 410 can also be made from other metals that result in Zero-Valent capabilities, such as copper, silver, platinum, palladium, nickel, tin, zinc, and the like. Alternatively, the metal fiber 410 may be bimetallic or an alloy of zero-valent metals, such as iron-nickel, iron-palladium, carbon steel, and the like.

Generally speaking, the metal fibers 400 are oriented as an isotropic mass in a randomized orientation after the metal fiber 400. The isotropic mass may be packed into the ZVIF packing 400 to form the fill 340. Alternatively, the metal fibers 400 are cut into staple lengths using a suitable metal fiber cutting apparatus 26 to give the metal fibers a predetermined length, as shown in FIG. 6A. After cut to the predetermined length, the metal fibers 400 may then be stacked to achieve a unit of isotropic mass. The cut fibers 21 are then fed into conventional textile apparatus which separates and blends the mass of fibers 21 in order to form a homogenous blend of fiber 29, as shown in FIG. 6A. The homogenous fiber mass 29 can then be carded in the garnett 31 to form a fiber web 33, which is readily understood by commonly assigned U.S. Pat. No. 6,249,941. The garnett 31 may be any suitable apparatus used in the textile field, with the spacing/number of the cylinders and the garnett wires depending on the size and strength of the metal fibers 21 being acted upon. The carding process generally imparts a slight “machine direction” to the fibers 21. Sufficient oil or other lubricant is retained on the fibers 21 of the homogenous fiber mass 29 when the web is processed by the garnett 31, to prevent undesirable fracturing or disintegration of the web 29. After carding by the garnett 31, the fiber web 33 is lapped by suitable textile apparatus 34 to form a multi-layer structure 37. The lapping apparatus 34 changes the orientation of the fiber web 33 as it is being deposited in successive layers. In this way, the orientation of adjacent ones of the layers 39 are rotated out of alignment from each other by a preselected angle, and the direction of the fibers 21 in the fiber web 33 varies between adjacent layers 39 of the resulting multi-layer structure 37 is interwoven may be used as the ZVIF packing 400.

In one embodiment, the multi-layer structure 37 is then fed through a suitable nip 41 and needled or needle-punched by textile apparatus 45, as shown in FIG. 6B. The needling of the multiple layers 39 interengages the fibers 21 of respective layers 39, giving the resulting ZVIF packing 43 improved strength, fiber density, and fiber distribution characteristics for selenium removal. The needling process causes the fibers 21 to be interengaged not only within respective layers 37 but also between the layers 37 (in the “z” direction relative to the layers). The x-direction is the longitudinal machine direction in which the fabric ply exits the textile apparatus. The y-direction is the transverse machine direction in which the fabric ply exits the textile apparatus. And the z-direction is the vertical direction in which the fabric ply exits the textile apparatus. The bias direction is any other direction 0-90 degrees between the x, y, or z-direction, and provides an interwoven and interengaged metal fiber 400 mass.

In one embodiment, the plurality of metal fibers 410 is shown in FIG. 3B. The metal fibers 410 include a random irregular cross-section and rough outer surfaces with barb projections 200 formed on the outer surfaces. The irregular cross-sections vary continuously along the length of the resulting fibers to provide generally curled metal fibers. The curled and barbed nature of the metal fibers allows strong interengagement and intertwining with each other and the nonmetal fibers. In one embodiment, the metal fibers 410 are produced by shaving a metal member with a succession of serrated blades, as disclosed in commonly assigned U.S. Pat. Nos. 6,249,941 and 5,972,814, which is hereby incorporated by reference. The succession of serrated blades has a variety of different serration patterns, so that the resulting individual fibers have barbed projections 200 and irregular cross sections with rough outer surfaces.

A suitable lubricant, such as oil, is preferably applied to the metal member as it is being shaved by the blades in sufficient quantity so that the metal fibers retain on their outer surface a carding-effective amount of the oil or lubricant. “Carding-effective amount” of oil or lubricant means that the metal fibers, when blended with the nonmetal fibers, can be carded without substantial breakage or disintegration. The lubricant optionally may be applied after the metal fibers are formed. The commonly assigned U.S. Pat. No. 5,972,814 discloses the process for shaving a metal bar to produce lubricated metal fibers and the use of such lubricated metal fibers. A carding-effective amount of oil generally may be in the range of about 0.3 to 1.0 wt. % oil, more preferably about 0.4 to 0.7 wt. %, based on the total weight of the metal fibers, although lesser or greater amounts may be used depending on the type and average diameter of the metal fibers and the amount and type of nonmetal fibers included in the blended fiber mixture. For example, as the weight percentage of nonmetal fibers relative to the metal fibers is decreased, the quantity of oil or lubricant necessary to provide a carding effective amount may tend to increase. Conversely, as the weight percentage of nonmetal fibers relative to metal fibers increases, the nonmetal fibers may act as a “carrier” for the metal fibers in the carding step, reducing the quantity of oil needed for carding without breakage of the metal fibers. Thus, a carding-effective amount of oil for carding various combinations and amounts of metal and nonmetal fibers can be readily determined on a case-by-case basis. Preferably, the metal fibers are made from carbon steel, as to ensure zero valence for the ZVIF packing However, the metal fibers 410 can also be made from bronze, carbon steel, copper, platinum, zinc, metal alloys (copper-tungsten) or included with a catalyst-coating for zero valent capabilities, and other suitable metals that can be shaved into suitable metal fibers to suit a variety of contaminant removal applications. The metal fibers can have an average cross sectional diameter of between about 25 and 125 microns.

The metal fibers 410 are cut into staple lengths using a suitable metal fiber cutting apparatus to give the metal fibers a predetermined length, ranging between about 1 inch to about 12 inches, more preferably less than about 6 inches. In one embodiment, the metal fibers may have a length of about 6 inches prior to carding. In another embodiment, post carding web having metal fibers of approximately 1 to 3 inches long, due to a certain amount of fiber breakage occurs during the carding process. The metal fibers include a relatively high aspect ratio, where “aspect ratio” means ratio of fiber length to fiber diameter. In one embodiment, the aspect ratio may be about 75 to about 85, where the high aspect ratio results in an increased interengagement along the length of the metal fiber. Alternatively, the aspect ratio may be about 25 to about 75 for a lower aspect ratio in smaller ZVIF packing examples.

Nonmetal Fibers

In one embodiment, the nonmetal fiber 420 is shown in FIG. 3C. Such fibers may be essentially any synthetic or natural staple fibers for making nonwoven fabric material, such as polypropylene, polyester, polyethylene, rayon, nylon, acetate, acrylic, cotton, wool, olefin, amide, polyamide, fiberglass and the like. In another embodiment, the nonmetal fibers are a bicomponent fiber. Bicomponent fibers are fibers extruded from two polymers from the same spinneret with both polymers contained within the same filament. The bicomponent fibers can be configured as sheath/core, side-by-side, or eccentric sheath/core arrangement. The bicomponent fibers provide for a uniform distribution of adhesive polymer to bind metal fibers and provide resiliency to the ZVIF packing The bicomponent fiber remains a part of ZVIF packing structure after laminating steps and adds integrity to the ZVIF packing structure. And, the bicomponent fiber provides sufficient lamination, molding, and densification of the ZVIF packing to give durability. The bicomponent fiber can also increase the resiliency of the ZVIF packing Alternatively, the nonmetal fibers may be low-melt polyethylene fibers, which melt and fuse together upon heat activation. In one embodiment, low-melt polyethylene fibers may leave no length of the fiber after heat activation and cooling, whereby the low-melt polyethylene fibers melts and sticks together metal and nonmetal fibers upon cooling.

The lengths of the nonmetal fibers may be from about 1 inch to about 12 inches, and are more preferably less than about 6 inches in length. In one embodiment, the nonmetal fibers have a length from about 1 to 3 inches. The nonmetal fibers may be cut to size by conventional means. The nonmetal fibers are less brittle than the metal fibers, and are generally unaffected by the carding process. The grade of the nonmetal fibers may range from about 1 denier to about 120 denier. In another embodiment, the nonmetal fibers may range from about 10 to 80 denier, or alternatively from about 18 to 60 denier. In general, the metal fibers will have an average cross-sectional diameter that is from ½ to 2-times the cross-sectional diameter of the nonmetal fibers. Alternatively, the metal fibers and nonmetal fibers will have similar average diameters and lengths. In one embodiment, ZVIF packing comprises synthetic polymer fibers, such as polyester or polypropylene fibers, having a grade of about 15 denier and metal fibers having an average cross section of about 15 microns. In another embodiment, the ZVIF packing comprises bicomponent fibers having a 12 denier and metal fibers having an average cross section of about 12 microns.

Crimped synthetic fibers having a repeating “V” shape 422 along their length such as that shown in FIG. 3C. Crimped synthetic fibers have about 3 to 10 “V” shaped crimps 422 per inch. Crimped fibers having about 7 crimps per inch being the most preferred. Of course, a greater or lesser degree of crimping may be selected as the particular application demands. Such crimped synthetic fibers are generally employed because they are readily carded by a garnett or carding machine and the crimped fibers increase the resiliency of the ZVIF packing Various crimped fibers may be used include carded fibers, spunbond fibers, bicomponent fibers, and meltblown fibers.

In another embodiment, the ZVIF packing 400 has a ratio of metal fibers to non-metal fibers of between about 10:1 and about 99:10, by weight. In another embodiment, the ZVIF packing 400 comprises about 75 to 95 wt. % metal fibers and about 5 to 25 wt. % nonmetal fibers. Alternatively, the ZVIF packing comprises about 85 to 92 wt. % metal fibers and about 8 to 15 wt. % nonmetal fibers.

As will be appreciated by those skilled in the art, metal fibers are several fold denser than nonmetal fibers-that is the specific gravity of metal fibers is substantially greater than the specific gravity of synthetic fibers and other nonmetal fibers. Accordingly, it will be understood that ZVIF packing may have relatively similar numbers of metal fibers and nonmetal fibers, even though, on a weight percent basis, the ZVIF packing is mostly metal.

It will also be appreciated by the person having ordinary skill in the art that “denier” is a measure of specific weight (or fineness) of a fiber which is arrived at by weighing a predetermined length of the fiber. (One denier equals 0.05 grams per 450 meters). Accordingly, different nonmetal fabrics having the same denier may have different cross-sectional diameters.

Fabric Media

In one embodiment, the ZVIF packing 400 is made by blending a predetermined amount of metal fibers 410 and a predetermined amount of nonmetal fibers 420 to provide a blend of metal and nonmetal fibers; carding the blended fibers to form a fiber web having metal fibers and nonmetal fibers distributed throughout; lapping the fiber web into a multilayered web structure; and needle punching the multilayered web structure to interengaged the fibers in adjacent layers to provide the fabric media 890, as shown in FIGS. 6C and 6D, and disclosed in commonly assigned U.S. Pat. Nos. 6,502,289 and 6,919,117, herein incorporated by reference.

In the blending step, the metal fibers 410 and nonmetal fibers 420 are blended prior to the carding step to obtain a substantially homogeneous mixture of the fibers, as disclosed in the commonly assigned U.S. Pat. No. 6,502,289. The blending of the staple fibers may be accomplished by various mechanical means. In one embodiment, two or more types of fibers may be mixed in an apparatus that is commonly known as a feedbox or blender and then fed directly into a carding apparatus. In another embodiment, a tandem feedbox arrangement may be used, that is an apparatus comprising two feedboxes in series, with the fibers being fed from the second feedbox directly into a carding apparatus. In another embodiment, the blending step may be performed by a series of apparatuses including a single feedbox, a precard machine to open up both the metal and nonmetal fibers and blend them, and a stock fan blower. Other, more elaborate blending lines may be used in the blending step. Any of these foregoing blending methods are suitable for use in accordance with the embodiments, depending on the degree of homogeneity desired for the ZVIF packing.

In one embodiment, a predetermined weight of staple length, shaved metal fibers 20 (60 micron average diameter, 0.6% oil by weight) and staple length polyester fibers 22 (60 denier, 7 crimps per inch) are introduced into a hopper 24 of a feedbox 26 in a ratio of about 91 wt. % metal fibers (including oil) to 9 wt. % nonmetal fibers. As shown in FIG. 6C, the hopper 24 has a hopper conveyor 28 that conveys the fibers to an incline conveyor 30 having a plurality of tines 32 extending from the conveyor belt 34, as to engage and carrying randomly oriented fibers 20, 22 up the incline conveyor 30. The feedbox 26 has a first spiked roller 40 which is spaced apart from incline conveyor 30 by a predetermined amount and rotates counter to the direction of travel of the incline conveyor 30. The incline conveyor 30 and the first spiked roller 40 comb the material to allow only a certain small amount of generally parallel fibers in a loose unstructured web to pass into a chute 36. A second spiked roller 42 rotating in the direction of travel of the conveyor assists in removing the thin layer of fibers 20, 22 from the tines 32 of the conveyor 30. The combing action of the first spiked roller 40 removes excess fibers which are “recycled”, or knocked back into the feedbox for further blending, resulting in a satisfactory distribution of metal 20 and non-metal fibers 22.

In FIG. 6C, the individual fibers 20, 22 that pass under first spike roller 40 drop through the chute 36 and onto a precard conveyor 38, and then are advanced through to a precard apparatus 44 to form an open precard web 46 of loosely entwined fibers 20, 22. As the precard web 46 exits the precard apparatus 44, the precard web 46 is sucked into an intake 48 of a stock blower fan 50, and then is blown into a condenser box 52 causing the fibers 20, 22 of precard web 46 to be randomized, as shown in FIG. 6D. The fibers 20, 22 then exit the condenser box 52 and are fed by a second feedbox conveyor 54 into a second feedbox 56, which is substantially identical to feedbox 26, which further mixes/blends fibers 20, 22 as indicated previously.

The blend of fibers 20, 22 is fed from second feedbox 56 into a shaker chute, and then into the garnett 58 and is formed into a web 60, as shown in FIG. 6D. The web 60 is transported to an incline conveyor 62 and into a lapping apparatus 64, where the web 60 is lapped to form a multi-layered structure 68. The lapping apparatus 64 feeds the web 60 downwardly onto an apron 66, while simultaneously moving the web 60 from side to side in an oscillating motion (as depicted by the arrows) to cause the web material to invert and fold-over upon itself each time the oscillating lapper changes direction. While the lapping apparatus 64 deposits successive layers of the web 60 on top of each other, apron 66 advances slowly in a direction perpendicular the axis of oscillation so that the web 60 is laid down in a Z-shaped pattern as the fabric inverts and folds back upon itself. In this manner, a continuous-length of a multi-layered ZVIF packing structure 68 is formed. The lapping step causes adjacent layers of web 60 to be laid on top of each other at a preselected angle. Because the fibers in each layer are relatively aligned, the direction of the fibers in adjacent layers of the ZVIF packing runs on the bias with respect to one another. The number of layers in the multi-layered web structure 68 as well as the degree of the bias between adjacent layers will be a function of the following variables: (i) the speed at which the web 60 is advanced through the lapping apparatus 64; (ii) the frequency of oscillation of the lapping apparatus 64; (iii) the width of the web 60; and (iv) the apron 66 speed. In one embodiment, the web 60 is advanced on the lapping apparatus 64 at a speed of 47 feet per minute, and the lapping machine is oscillated at between 2-10 oscillations per minute. In another embodiment, the width of the web is between 20 to 60 inches and the apron speed is set between 5 to 50 feet per minute. However, the material can be manufactured on larger textile equipment that can produce widths of material up to 200 inches.

The multi-layered web structure 68 is then fed through a compression apron 70, as shown in FIG. 6E, to slightly compress the multi-layered structure 68, and needled by a needle-punch apparatus 72 to form a ZVIF packing 400. The needle-punch apparatus 72 comprises a first punch board 74 having a first set of barbed needles 76. The first punch board 74 reciprocates up and down and punches the multi-layered web structure 68 from the top side to interengage fibers on the down-stroke. The needle-punch apparatus 72 further comprises a second punch board 78 having a second set of barbed needles 80. The second punch board 78 reciprocates up and down and punches the multi-layered web structure 68 from the underside to interengage fibers on the upstroke. The resulting needle punched web structure 68 forms the fabric media 890. The interengagement of the metal and nonmetal fibers provides for neighboring fibers in an orientation for strong intertwining and interengaging to increase resiliency and durability of the fabric media 890.

The fabric media 890 may be needlepunched to a low penetration of a needle per square inch (“PPSI”) so that the puncture density will maintain the resiliency of the ZVIF packing and compress the metal and nonmetal fibers to a sufficient degree. PPSI is a function of strokes per minute (R), needles per 1 inch width (D) and inches per minute of material traveled (S), where PPSI=(R×D)/S. In one embodiment, the fabric media 890 is needlepunched to a penetration of 400 PPSI, with a range of 300-500 needles per square inch. A high penetration of a needle per square inch and a high puncture density decreases the resiliency of the fabric media 890, as it would compress the metal and nonmetal fibers to a greater degree. Radial resiliency of the fabric media 890 and a lower puncture density can rely more on the heat fusing step below for strength and compressibility to spring back to a thickness when in the helical configuration 894, as the nonmetal fibers adhere to other nonmetal fibers and metal fibers.

FIG. 2B shows one embodiment of the fabric media 890. The needle punching of the multi-layered structure 68 interengages the fibers of respective layers, giving the resulting fabric media 890 improved strength, fiber density, and resiliency. The needling process causes the metal 20 and nonmetal 22 fibers to be interengaged in and between the layers (in the “z” direction relative to the layers, as shown in FIG. 6C-6E). Because the fibers of the fabric media 890 are interengaged in the x and y axes during the carding step, the resulting, needle-punched fabric has the fibers interengaged in the x, y, and z directions to form an isotropically strong, coherent composite structure having desirable properties of resiliency and durability.

The needles 76 and 80 of the needling punching apparatus 72 includes a gauge, a barb, a point type and a blade shape (i.e. pinch blade, star blade, conical, and the like). In one embodiment, the gauge of the needle may be between about 20 to about 40 gauge with a regular barb. The major components of the needle include the crank, the shank, the intermediate blade, the blade, the barbs, and the point. The crank is the 90 degree bend on the top of the needle and seats the needle when inserted into the punch boards 74 and 78. The shank is the thickest part of the needle. The shank is that part of the needle that fits directly in the punch board itself. The intermediate blade is put on fine gauge needles to increase flexibility, which is typically put on 32 gauge needles and finer. The blade is the working part of the needle and is what passes into the multi-layered structure 68 and is where the all barbs are placed. The barbs carry and interlock the metal and nonmetal fibers. The shape and sized of the barbs can dramatically affect the ZVIF packing 400. The point is the very tip of the needle. In one embodiment, the felting needles are 32 gauge regular barb needles with a pointed end including three sided needles with 3 barbs per blade.

As the punch boards 74 and 78 move up and down, the blades of the needles 76 and 80 penetrate the multilayered web structure 68, as shown in FIG. 6E. Barbs on the blade of the needles 76 pick up the metal and nonmetal fibers on the downward movement and carry these fibers through the depth of the penetration. The draw roll pulls the multi-layered structure 68 through the needle punching apparatus 72, as the needles reorient the metal and nonmetal fibers. Generally speaking, the more the needles 76 and 80 penetrate the multi-layered structure 68, the denser and more resilient the fabric media 890 becomes; however, beyond some point, damage may result to the metal and nonmetal fibers from excessive needle penetration and decreased resiliency.

The needle punching apparatus 72 includes machine variables of the depth of penetration and puncture density. The travel of the metal and nonmetal fibers through the ZVIF packing depends on the depth of penetration of the needles 76 and 80. The maximum penetration is fixed by the needles 76 and 80 of the needle punching apparatus 72 and depends on the length of the three sided shank, the distance between the needle plates, the height of stroke, and the angle of penetration. The greater the depth of penetration, the greater the entanglement of fibers is within the multi-layered structure 68, because more barbs are employed per penetration. In one embodiment, the penetration depth may be between about ½ of an inch to about 1 inch.

The puncture density is the number of punches on the surface of the feed in the web. The puncture density is a complex factor and depends on the density of needles in the needle board (Nb), the rate of material feed (V), the frequency of punching (F), the effective width of the needle board (W), and the number of runs. The puncture density per run Edₚₐₛₛ=[n*F]/[V*W], where, n=number of needles within the punch boards, F=frequency of punching, V=rate of material feed, and W=effective width of the needle board. The puncture density in the needled fabric Ed_{NV} depends on the number of runs Nₚₐₛₛ; Ed_{NV}=Edₚₐₛₛ*Nₚₐₛₛ. The frequency of punching is formulated in the PPSI formula. The thickness, basis weight, bulking density and air permeability provide information about compactness of ZVIF packing and are influenced by a number of factors. If the basis weight of the ZVIF packing and puncture density and depth are increased, the ZVIF packing density increases and air permeability is reduced (when finer needles and longer, finer and more tightly crimped fibers are used). Preferably, the basis weight of the ZVIF packing, puncture density, and penetration depth are maintained to result in a resiliency greater than steel or copper wool. In one embodiment, the needles per inch width are 96 needles and the resiliency of the ZVIF packing is about 2 to 5 times greater than steel or copper wool. Alternatively, the frequency of punching is formulated in the PPSI formula, where the penetrations per square inch may be determined from P=RD/S, where P is the number of needles penetrations per square inch, R is the machine speed in strokes per minute, D is the number of needles per inch of machine width, and S is the web speed in inches per minute. In one embodiment, R is about 300 strokes per minute, D is 96 needles per inch of the machine width, and S is about 72 web speed inches per minute, thereby resulting in about P or PPSI of about 400. In another embodiment R is between about 200 to about 600, D is between about 54 to about 96, S is between about 48 to about 144, and PPSI is between about 75 to about 1200.

Alternatively, the thickness, basis weight, density and air permeability provide information about compactness of fabric media 890 and are influenced by a number of factors. If the basis weight of the fabric media 890 and punch density and depth are increased, the fabric media 890 density increases and air permeability is reduced. Preferably, the basis weight of the fabric media 890, punch density, and penetration depth are maintained to result in a resilient material. In one embodiment, the needles per inch width are 96 needles and the resiliency of the fabric media 890 fabric is about 90%. In one embodiment, the resiliency is between about 50% to about 95%, which depends on what material is placed on top of the fabric media 890, such as rocks, mulch, and the like.

As far as the strength of the ZVIF packing 400, the situation is similar to that for compactness, namely that finer needles, finer and longer fibers, greater ZVIF packing basis weight and greater puncture depth and density, result in increased strength and resiliency of the ZVIF packing However, once a certain critical puncture depth or density has been reached, the rise in strength and resiliency may be reversed. If the depth of the barb is decreased or the distance between the barbs is increased, the dimensional stability is improved during needling, and the web density, resiliency, and maximum tensile strength in relation to basis weight can be raised. The resiliency of the ZVIF packing is determined from the penetrations per square inch (“PPSI”), the needle penetration depth, and the type of needles that are being used. The frequency of needle punching is part of the equation for figuring out the PPSI, as indicated above. Alternative punching apparatuses include different needle densities and different needle patterns, which affect the tightness or resiliency of the ZVIF packing.

The weight of the metal fibers can be as high as about 2500 g/m². By needle punching the fabric media 890, the required density can be obtained. The required density can also be obtained by optionally using increased metal fibers on different length portions of the fabric media 890. A gradient weight variance of the metal fibers along different portions of the fabric media 890 allow the fabric media 890 to include high density areas on the perimeter of the fabric media when rolled into the helical configuration 894, where high concentrations of contaminants are most likely to be located and then areas of lower density of the metal fibers along the inner zones of the helical configuration 894, where contaminants are not likely to be located and where greater flow through of water may be desired.

In one embodiment, a heat-fusing step fuses at least a portion of the nonmetal and metal fibers at their intersections to increase the resiliency, strength, and durability of the fabric media 890. As shown in FIG. 6F, a heat-fusing step may be carried out after the needle-punching step by heating the fabric media 890 to a predetermined temperature that is at least equal to the melting point of the nonmetal fibers. In one embodiment, the temperature is from about 10 to 50° C. or more above the melting point of the synthetic fibers. Heat is conducted to the ZVIF packing for an amount of time sufficient to cause the outer surface of the synthetic fibers to at least partially melt so that upon cooling the synthetic fibers fuse to other fibers with which they are in contact. Upon heating the nonmetal fiber, the different molecular orientations in the fiber will exhibit different shrinkage behaviors that result in a random, three dimensional crimp in the fiber. This heat induced or latent crimp is induced upon application of heat to the nonmetal fiber and the degree of crimp depends on the temperature to which the nonmetal fiber is subjected. And such a heat fusing of the nonmetal fibers with metal fibers in the ZVIF packing increases the strength and resiliency in the ZVIF packing for gripping to cracks and crevices. The adhesive nature of the nonmetal fibers can be selected to increase the resiliency of the ZVIF packing when subjected to the heat fusing step.

With reference to FIG. 6F, the heating step may be carried out by passing the ZVIF packing 400 through a pinch roll apparatus comprising a heat-conductive roll 84 and a resilient (e.g., rubber) roll 86, with the clearance between the pinch rolls set to at least partially compress the ZVIF packing 400 while it is in contact with the heated pinch roll. The amount of time the ZVIF packing spends in contact with the heated roll may be adjusted depending on the amount of melting of the synthetic fibers desired. The ZVIF packing may contact the heated roll between 3 and 10 seconds. As will be appreciated, the amount of fusion between the fibers will be greatest at the surface contacting the heated roller. Optionally, two or more such pinch roll devices may be used in series so that both surfaces of the ZVIF packing are brought into direct contact with a heat conductive roll 84 to fuse the fibers of the ZVIF packing 400. The resulting ZVIF packing 400 can have thickness between ⅛ inch to 1 inch. Such thicknesses are to be determined based upon the contaminant removal and flow properties of the container vessel.

Other methods of heating and melting the synthetic fibers include compressed hot air, direct radiant heating such as with an oven, or laminating the nonmetal fibers with adhesives. “Laminating” means securing nonmetal fibers together or to metal fibers by any adhering process, such as heat application, adhesives, pressure, mechanical bonding, or any combinations thereof. Laminating forms a bond between two surfaces; this may be a thermal bond, a chemical bond, or a mechanical bond. Adhesives may be any suitable material that is compatible with the nonmetal fiber and the metal fiber. Laminating the nonmetal fiber and the metal fiber increases the stability, strength, and deterring properties of the ZVIF packing 400.

The density of the metal and nonmetal fibers 100 to about 3000 g/m². By needle punching, lapping, and laminating the ZVIF packing 400, the required density for the desired elemental removal operation can be obtained. For high amounts of contaminants, a higher density of 2500 g/m² to result in an increased resiliency. For smaller amounts of contaminants, a lower density of 500 g/m² may be for the ZVIF packing. Alternatively, the ZVIF packing may include a density gradient, whereby one end of the ZVIF packing includes an increased density of 1000 to about 2000 g/m², and another end of the ZVIF packing includes a lower density of about 500 to about 1000 g/m².

Water Treatment Cells

As shown in FIG. 7M, an alternative form of the water treatment cell 100 comprises the container vessel including a porous bag 300 with the ZVIF packings 400. The porous bag 300 includes a plurality of lift straps 310, a porous bag wall material 320, a porous bottom 330, and a fill 340 of the ZVIF packing 400. The porous bag wall material 320 and the porous bottom 330 includes pores or a mesh cut pattern, such that the fill 340 of the ZVIF packing 400 is maintained and securely held within the porous bag 300 and the fluid flow is transmitted through the porous bag 300.

The fill 340 includes a controlled porosity and density D of the ZVIF packing 400 to treat a particular amount of fluid flow rate and allow for a particular contact time of the water of interest with the ZVIF packing 400. The fill 340 may be defined by the density D of the ZVIF packing 400 and the average diameter d of the metal fibers 410. In one embodiment, the fill 340 can range in densities from 1 lb/ft³, 5 lb/ft³, 10 lb/ft³, 15 lb/ft³, 20 lb/ft³, 25 lb/ft³, to 50 lb/ft³. The fill 340 may include a variation of densities using the same diameter d of metal fiber from the bottom of the treatment cell 100 to the top of the treatment cell 100 by use of a plurality of porous bag layers 350, as shown in FIG. 7B. Alternatively, the fill 340 may include a plurality of porous bag layers 350 of the same density D of the ZVIF packing 400 with differing metal fiber diameters d ranging from the bottom of the treatment cell 100 to the top of the treatment cell 100. Alternatively, the fill 340 may include a plurality of porous bag layers 350 with differing densities D of the ZVIF packing, whereby each different porous bag layers 350 include differing metal fiber diameters d within each porous bag layer 350. Alternatively, the fill 340 includes a gradient of metal fibers with diameter d in the vertical direction indicated by the z-axis in FIG. 7B, or in the along either horizontal direction indicated by the x-axis and y-axis in FIG. 7B. In all, the density D of the ZVIF packing and the average diameter d of the metal fiber 410 define the total surface area available for selenium removal, further described below. Porosity is the free space in the ZVIF packing 400 in the fill 340 for fluid flow and relates to the maximum fluid flow rate and the volume %. The fluid flow must travel around the metal fibers 410, so the travel path of the fluid flow through the metal fibers 410 is tortuous and decreases the fluid flow rate. Volume % is the percentage of the total volume occupied by ZVIF packing 400 relative to the percentage of open space between the metal fibers 410. In one embodiment, the ZVIF packing 400 exceeding 2 volume % may have difficulty sustaining good fluid flow rates. 2 volume % of ZVIF packing 400 has 98% open space in the volume and 2% space occupied by the ZVIF packing 400. In one embodiment, the volume percentages of ZVIF packing may be 0.01 volume % to 0.09 volume %, 0.1 volume % to 1 volume %, 1.1 volume % to 1.9 volume %, and the like.

In one embodiment, the selenium removal process and apparatus includes a plurality of treatment cells 100 and a holding tank 500, as shown in FIG. 7A. The water of interest flows into the holding tank 500 through an inflow port and includes an overflow port. The holding tank 500 is fluidly connected to a manifold 510 by way of valve 512. The manifold 510 includes a plurality of valves 520, which fluidly communicate to a plurality of treatment cells 100. Generally speaking, the treatment cells 100 are described as previously indicated, and may include any number of treatment cells, which are designated as treatment cells A, B, C, D, and E in FIG. 7A. FIG. 7A displays the plurality of treatment cells 100 arranged in parallel. To treat larger systems and to handle a larger flow volume, after the parallel configuration of the plurality of treatment cells 100, sequential treatment cells 100 may be attached to the treatment cells A, B, C, D, and E, as shown in FIG. 7B. Such a distribution between 5 separate treatment cells into a series train may handle 100 gallon/minute fluid flows. For the series configuration, there can be any number of porous bag layers if required by the levels of selenium.

A parallel configuration of the treatment cells 100 distribute the flow to allow an adequate residence time in the treatment cells 100. Depending on the particular flow rate of the contaminated water, additional treatment cells 100 may be added or shut off by the valve system in the manifold. 510. Moreover, when the treatment cells 100 may be configured in a serial or sequential fashion, one treatment cell 100 is placed in fluid connection with another treatment cell 100, as to give a serial contamination removal processes for additional contaminant removal.

A side view of one embodiment of the treatment cell 100 is shown in FIG. 7C. The inlet port 210 is located on the bottom of the container vessel 200 and fluid flow from the manifold is indicated by arrow 212. A plurality of spacers 230 are located on the bottom of the container vessel 200 to permit the water to flow into the bottom of the container vessel 200. A porous plate 240 separates the spacers 230 and the porous bag 300. The porous bag 300 includes the fill 340 of the ZVIF packing 400 to remove selenium. The treated water then flows out of outlet port 220 by way of fluid flow indicated by arrow 220, to either another treatment cell 100 or discharged consistent with the objectives of the treatment system.

As shown in FIG. 7D, in one embodiment, the porous bag 300 may include a plurality of porous bag layers 350 of different densities of ZVIF packing 400. The porous bag layers 350 include a plurality of lift straps 370, a porous bag wall material, a porous bottom, and a fill of the ZVIF packing 400. The porous bag layers 350 are discrete and separate layers, where each porous bag layer may include a specific density of ZVIF packing 400. The plurality of porous bag layers may be implemented to accomplish different objectives, such as: (a) ease of maintenance and recharge by decreasing the weight of individual porous bag layers 350; (b) use of porous bag layers containing different densities of ZVIF packing 400 to accomplish more efficient target substance removal; (c) the use of inserts composed of differing average cross-sectional diameter d of the metal fiber 400 to accomplish more efficient target substance removal, and combinations of (b) and (c) to accomplish more efficient target substance removal. The porous bottom on one porous bag layer 350 separates the porous bag layer 350 from each one another. The porous bag layers 350 may include layers 352, 354, 356, 358, 360, and 362, wherein each layer may include different densities of ZVIF packing 400, including, but not limited to, 1 pound cubic foot, 5 lb/ft³, 10 lb/ft³, 15 lb/ft³, 20 lb/ft³, 25 lb/ft³, to 50 lb/ft³ for example, the bottom layer 352 may include a density of 5 lb/ft³ as to prevent clogging of the bottom layer 352. The middle layers 354, 358, 360, and 362 may have an increased density of 20 lb/ft³, to permit increased selenium removal once the contaminated water is within the treatment cell 100. And the top layer 364 may include a density of 5 lb/ft³. In one embodiment, the porous bag layers 350 include metal fibers of any cross-section diameter d at any density. The porous bag layer 350 can be of any thickness and weight, and the stacking of the porous bag layers 350 may be dictated by the system requirements, removal, and the like.

As shown in FIG. 7E, is a cut-away of treatment cell 100 with the plurality of porous bag layers 350. The porous bag layers 350 may be reinforced with straps spanning the diameter of the porous bag layers on the top and side layer. The porous bag layers 350 include the ZVIF packing 400 and are stacked upon each other to allow for replacement and removal of individual porous bag layers 350 as need be. The lift straps 370 are shown in FIG. 7F, as well as the reinforced porous bag material 390.

In an alternative embodiment, the treatment cell 100 may include a compressed gas line 372 in between one of the layers 352, 354, 356, 358, 360, and 362 to emit a plurality of gas bubbles 374, as shown in FIG. 7G. A space 368 can be created between any (or all) of the porous bag layers and the compressed gas sparge line 372 is inserted in the space 368, as shown in FIG. 7H. The location of the space 368 and insertion of the gas line may be at the bottom layer, as shown in FIG. 7H., or if there are multiple gas lines 372, the gas lines 372 may be placed between multiple porous bay layers, as shown in FIG. 7I. The gas sparge line 372 is fit between porous bag layers using a spacer to provide for the space 368, more specifically shown in FIG. 7J. The spacer may include a matrix to provide support for the gas line 372, wherein the spacer could be made of plastic, metal, or any other suitable material. The gas line 372 may include a circular or spiral configuration to provide for sufficient gas to be emitted throughout the porous bag layers, as shown in FIG. 7J. Alternatively, the gas line 372 may be in an “X” configuration with properly sized holes. The gas line 372 may include a air flow meter, an air pressure gauge, and an air regulator to regulate the amount and pressure of the gas being emitted into the treatment cell 100. The location of the gas line 372 may be dependent upon which type of contaminant is to be filtered or removed. In one embodiment, if the contaminant is heavier in water, then the gas line is placed on or close to the bottom layer. Alternatively, the gas line is placed in a layer where the water becomes oxygen depleted due to iron oxidation, and the bottom layer is the layer where the oxygen becomes depleted due to iron oxidation. Alternatively, if the contaminant is lighter in water, the gas line 372 is placed towards the top layer of the treatment cell. The treatment cell may be targeted to remove dissolved contaminants, thus if the contaminants are dissolved and the water is flowing through, buoyancy should not factor into the flow through.

Depending on the type of compressed gas, different mechanisms enhance the removal of aqueous contaminants from the water. If air is injected, the oxygen in the air restores some of the dissolved oxygen that was depleted due to iron oxidation in ZVIF inserts below the injection point. The restoration of dissolved oxygen in the water allows the iron in the ZVIF inserts to oxidize further, creating more oxidized particles for the aqueous contaminants to adsorb onto. In order to restore dissolved oxygen, the bubble size may be smaller as to increase the surface area of the bubble to arrive at a higher dissolve rate allowing for more oxygen-to-water contact and the need to supply less air overall in the system. In one embodiment, the bubble size may be between about 1/100 inch to about ½ inch; alternatively, between about 1/50 inch to about ⅓ inch; alternatively between about 1/25 to about ¼ inch; alternatively, between about 1/16to about ⅙ inch. The further the sparge line gets from the air source, the bubble will experience a pressure drop in the sparge line and the bubble size will change subsequently. Additionally, the water agitation caused by the compressed air percolating through the ZVIF inserts causes greater contact between the contaminants and the iron in the ZVIF, increasing the chances and rate of the contaminants in reducing to lower valent species and adsorbing to the oxidized iron and/or reducing to elemental species and becoming insoluble. Both the added oxidation from adding oxygen (from air) as well as agitation caused by the bubbling contributes to enhanced reduction/adsorption of contaminants. Other types of compressed gases may yield similar or even enhanced contaminant removal benefits, such as nitrogen, oxygen, argon, carbon dioxide. The type of gas may be dependent upon the type of contaminant for removal. For example, if the contaminant is on the same size as Nitrogen gas, then Nitrogen gas increases the contact and bump of the contaminant into the ZVIF inserts.

Also, depending on the amount of compressed gas (Standard Cubic Feet per Minute corrected for temperature, “SCFM”) and gas delivery pressure (Pounds per Square Inch, “PSI”), the reduction/adsorption reaction can be altered to yield maximum contaminant removal efficiency. A range in the amount of compressed gas to be delivered may be between about 1 SCFM to about 50 SCFM, alternatively, between about 5 to about 40 SCFM, alternatively, between about 10 to about 30 SCFM, alternatively between about 15 to about 25 SCFM. Also, this range in the amount of compressed gas may be related to the density of the ZVIF inserts, i.e. a higher SCFM for a higher density of the ZVIF inserts, such that the amount of compressed gas is between about 10 to 50 SCFM for a ZVIF insert density between about 25 lb/ft³ to 50 lb/ft³. Preferably, the amount of compressed gas is between about 5 to 20 CFM and the ZVIF insert density is between about 5 to about 25 lb/ft³, alternatively, about 15 lb/ft³, to remove about 50 μg/L of selenium at a flow rate of about at 20 GPM to about 30 GPM. Regarding adding higher amount of gas flow, there is a threshold point where the ZVIF inserts could become dislodged from the treatment cell and cause water channeling that is not preferred. A range of the gas delivery pressure may be between about 5 to about 100 PSI; alternatively, between about 10 to about 80 PSI; alternatively, between about 15 to about 70 PSI; alternatively, between about 20 to about 60 PSI; alternatively, between about 25 to about 50 PSI; alternatively, between about 30 to about 40 PSI. Additionally, the gas line can include a plurality of air injection points. In one embodiment, the gas line includes 3 air injection points, as shown in FIG. 7J.

In one embodiment, the gas delivery pressure may be related to the density of the ZVIF inserts, i.e. higher PSI may be needed for a higher density of the ZVIF inserts. In one embodiment, the gas delivery pressure may be between about 1 to about 100 PSI; alternatively, between about 10 to about 80 PSI; alternatively, between about 15 to about 70 PSI; alternatively, between about 20 to about 60 PSI; alternatively, between about 25 to about 50 PSI; alternatively, between about 30 to about 40 PSI. Preferably, the gas delivery pressure is about 30 PSI with a ZVIF insert density between about 5 to about 25 lb/ft³.

The flow rate of the water treatment cell may be between about 1 to 50 gallons per minute (GPM), alternatively between about 5 to about 40 GPM, alternatively, between about 10 to about 30 GPM, alternatively, between about 20 to 25 GPM. By applying the gas cell line, the flow rate may be increased or decreased depending on the amount of the gas being delivered to the treatment cell. At a target flow rate of 20 GPM, approximately 100% removal of selenium may be achieved in one embodiment. At a higher flow rate 30 GPM, the removal of selenium may be decreased as the rate at which the contaminant is being moved through the treatment cell is at a too high of rate for the ZVIF inserts to remove the selenium, where the removal of selenium may be approximately less than 100%, in one embodiment.

As shown in FIG. 7K, a pH control system 700 is placed before the water treatment cell 100 in one embodiment. The acceptable range for the water's pH for selenium removal in ZVI systems is between 6 and 8, and within this range, the lower the pH, the removal of selenium is increased via accelerated redox reaction kinetics. When the pH of the water is closed to 6, the ZVIF packings 400 can more readily reduce selenate to selenite and selenite to elemental selenium. One method for lowering the pH of water comprises dissolving carbon dioxide (CO₂) in a closed system 700 into the influent water 702, thus forming carbonic acid (H₂CO₃) into the influent water and lowering the pH by consuming alkalinity. Alternative gases can be used to lower the pH of the influent water, for example Acid gas, which may be a natural gas or any other gas mixture which contains significant amounts of hydrogen sulfide (H₂S), carbon dioxide (CO₂), or similar contaminants. An acid gas is any gas that contains significant amounts of acidic gases such as carbon dioxide (CO₂) or hydrogen sulfide. Thus, any acidic gas that lowers the pH of the influent water may be used; however, CO₂ is used below for exemplary purposes.

Before a raw natural gas containing hydrogen sulfide and/or carbon dioxide can be used, the raw gas must be treated to reduce impurities to acceptable levels and this is commonly done with an amine gas treating process. The removed H₂S is most often subsequently converted to by-product elemental sulfur in a Claus process or alternatively converted to valuable sulfuric acid in a WSA Process unit.

The method comprises using CO₂ to lower the pH before interacting the influent contaminated water 702 with the ZVIF packings 400, which has the advantages of not having to use acidic chemicals with precise measuring and metering systems that respond to changes in influent pH and flow rate. CO₂ has a buffering capability in water; i.e., a constant flow of CO₂ will yield similar pH lowering results across a wider range of flow rates and influent pH.

Generally speaking, the method comprises infusing regulated, gaseous CO₂ into the influent water 702 (see FIG. 7K) from an enclosed CO₂ regulator 710 via a porous diffuser 712. The influent water 702 is then further blended inline with a static mixer 714 for a maximum effect of mixing the gaseous CO₂ with the influent water 702. The amount of CO₂ required to achieve a particular pH is mainly dependent on the pH of the influent water 702, its alkalinity and the flow rate; other minor factors such as water temperature will also affect the amount of CO₂ required to achieve a target pH. Sensors for the alkalinity, the flow rate, and temperature for the influent water 702 may be placed before the porous diffuser 712, such that the CO₂ regulator 710 may deliver the appropriate amount of CO₂ into the influent water 702.

Since a pH near 6 improves selenium removal using elemental iron, but too low a pH below 6 will increase the rate of iron dissolution, thus pH control near 6 is essential. In a system with carbonate alkalinity, addition of CO₂ will lower the pH below 6 with great difficulty due to buffering. Mineral acids would easily overshoot pH 6 without precise metering. Use of CO₂ in a closed system allows more gas to dissolve than in an open system. The entry point of CO₂ to the treatment tank 100 is not exposed to the atmosphere, thus added CO₂ raises the partial pressure of CO₂ in the airspace above the flow, increases the solubility of CO₂ and allows the pH to be lowered. Water exposed to the open atmosphere outgases CO₂ and lowering the pH to 6 is difficult. After contact with the water treatment cell 100 and the ZVIF packings, the effluent water 704 with a low pH water will once again be in contact with the atmosphere and excess CO₂ will outgas, moderating the pH effect on the effluent water 704.

Combining CO₂ with water to form carbonic acid thus lowering the water's pH is a basic chemical reaction; applying this reaction to ZVIF based selenium reduction systems to enhance selenium removal from water. The apparatus comprises elements to diffuse and mix the CO₂ with water. A diffuser 712 consists of a Y-strainer housing that has been retrofit with a length of porous hose. The porous hose is placed inline with the water flow for maximum diffusion of CO₂ in the water stream. A static mixer 714 is operably coupled downstream of the diffuser is which further blends the CO2 with the water.

The pH control system 700 generally comprises: (1) lowering the pH of water comprising dissolving CO₂ in a closed system into the influent water to form carbonic acid and lowering the pH without the use of acidic chemicals coupled with precise measuring and metering systems that respond to changes in influent pH and flow rate; (2) regulating and infusing gaseous CO₂ into the influent water through a porous diffuser comprising a Y strainer housing that is coupled with a length of a porous hose, coupling the porous hose inline with the water flow for maximum diffusion of CO₂ in the influent water, and blending the CO₂ inline with a static mixer that is downstream of the diffuser to further blend the CO₂ with the influent water; (3) regulating the amount of CO₂ to achieve a target pH between 6 and 8 by testing the pH of the influent water, testing the alkalinity of the influent water, testing the flow rate of the influent water, and testing the water temperature of the influent water; (4) using CO₂ in a closed system to allow more gas to dissolve than in an open system and not exposing the entry point of CO₂ to the treatment tank to the atmosphere, and raising the partial pressure of CO₂ in the airspace above the flow to increase the solubility of CO₂ and lowering the pH; and (5) contacting the pH water between 6 and 8 with a plurality of ZVIF packings, and then contacting the effluent water from the ZVIF packings with the atmosphere and outgasing excess CO₂ to moderate or neutralize the pH effect on the effluent water from the treatment tank.

In an alternative embodiment for the treatment cell 100, the bagless inserts 812 are used in a tube apparatus 820 that includes a plurality of cylinder tubes 822 or tanks, as shown in FIG. 7L. Generally, the tube apparatus 820 does not include the carriers but may include carriers in alternative embodiments. The tube apparatus includes a filter 824 for the inflow of water 830 operably coupled to a pump 826 and a pressure gauge 828. The inflow water 830 is operably coupled to an inlet manifold 832 to distribute the inflow of water 830 to the plurality of cylinder tubes 822. Before entering the plurality of cylinder tubes 822, the inflow water 830 may pass through a flow control apparatus 834 for controlling the pressure of the inflow water into the cylinder tubes 822. In one embodiment, the flow rate is between about 2 gallons to 100 gallons per minute (gpm), alternatively between about 30-80 gpm, alternatively between about 40-60 gpm. The cylinder tubes 822 may include any number of bagless inserts 812 of any particular ZVIF packing density. In one embodiment, the bagless inserts 312 include a reeled configuration of about between about 5 to 40 lbs per square foot (“psf”), alternatively, between about 10 to 30 lbs psf. In one embodiment, the cylinder tubes 822 include between about 3-30 bagless inserts 812, alternatively, between about 5-25 bagless inserts 812, alternatively, between about 10-20 bagless inserts 812. The selection on the number of bagless inserts 812 and the density of the inserts may be selected according to the level of contaminants in the inflow of water. After the inflow of water has been treated by the cylinder tubes 822, a throttle 836 may relieve any back pressure and allow for the outflow of water 838 out the tube carrier apparatus 820.

Water Delivery Systems

Using the zero valent reaction, dissolved aqueous selenium may be removed by coming in contact with the ZVIF packings, thus proper mass transfer, and/or proper water flow through the entire media may be employed. ZVIF packing configurations and media embodiments may be altered for proper water delivery and flow through the media while in the treatment tank. Uneven water distribution caused by high and low pressure zones in the treatment tank can cause water to flow preferentially through only particular portions of the media. Preferential water flow may cause decrease elemental removal caused by diminished residence time in the ZVIF packing media as well as lower selenium removal media life due to oxidizing the media more rapidly in the preferential flow areas.

Many water distribution and delivery systems may be employed with the ZVIF packings and configurations within various water treatment cells. In one embodiment, carbon metal fiber media may include a varied density. In one embodiment, the interior of the metal fiber media may include a lower density, while the exterior of the metal fiber media may include a higher density. For example, the exterior of the metal fiber media may include a 100% density outside, the middle of the metal fiber media may include an 80% density, and the core of the metal fiber media may include a 70% density. In another embodiment, coarser or larger metal fibers may be used in the lower half of the media and finer or smaller metal fibers may be used in the upper half media, which lowers water resistance as the water flow enters the media and promotes even flow throughout.

In another embodiment, each media insert has a hollow core that is plugged with a water impermeable barrier to prevent water flow from bypassing the media through the core. With the top of the core plugged, the lower half of the core includes a plurality of holes to encourage water flow to enter the middle of the media and radiate outward.

In another embodiment, water oxidizes the metal fiber media starting at the entry point and that spent or oxidized media typically has unused or un-oxidized metal fiber media towards the exit point of the treatment cell. Water flow may be reversed from the exit point to the entry point or water inlet after running for a period of time in order to use the media more efficiently, whether the treatment cell is a bottom-up or top-down water flow system.

In another embodiment, a ring is employed at the bottom of the treatment cell to effectively block initial water flow from the outermost diameter of the metal fiber media. As such, the ring includes a diameter fitted to the outermost circumference of the metal fiber media.

After the water flow initially passes through the inner diameter of the metal fiber media, the water flow is allowed to radiate outward and upward through the media. Thus, the water flow is coaxially distributed throughout the concentric metal fiber media from the center to the outer diameters. Again, water flow may be reversed and distributed from the outer-most diameters of the metal fiber media towards the inner diameter to optimize any un-oxidized metal fiber media.

In one embodiment, a water distribution array 1000 is shown FIGS. 7P-7Q to direct water flow 212 into the specific areas of the ZVIF packings 400 or other media and the treatment tank 100. Such an array 1000 is designed to prevent water from preferentially flowing through high pressure areas in the lower portion of the water treatment tank. High pressure areas are typically at the water inlet 210 and higher pressure is experienced at higher fluid flow rates. The water distribution array 1000 in FIG. 7P includes at least one horizontal member 1002 and at least one vertical member 1004, wherein both the horizontal member 1002 and one vertical member 1004 includes a plurality of holes 1010 in fluid communication with a lumen disposed within each horizontal and vertical member 1002, 1004. The vertical member 1002 traverses the vertical height of the treatment tank, while the horizontal member 1004 traverses the horizontal length of the treatment tank. Alternatively, the distribution array may include two horizontal members 1002 coupled to the top or bottom of the vertical member 1002, whereby the first horizontal member is offset from the second horizontal member by at least about 90 degrees. At least one of the horizontal or vertical members 1002, 1004 is in fluid communication with the water inlet 210 to distribute the water flow 212.

In one embodiment, the holes 1010 are on the bottom of the array 1000; alternatively, there are more holes per unit length at the low pressure end of each member. This is designed such that water is distributed evenly to the ZVIF packings 400 by eliminating high and low pressure areas in the tank 100. Alternatively, the array 1000 could be configured in a different arrangement, whereby there is a plurality of vertical members 1004 in fluid communication with the horizontal member 1002, or a plurality of horizontal members 1002 in fluid communication with the vertical member 1004. Alternative geometrical configurations for the members may assume a circular, ellipsoidal, polygonal, triangular, hexagonal configuration for the distribution array 1000. Alternatively, the holes 1010 could be placed on the top of the array, on the side of the array 1000, or at angles with respect to the horizontal axis of the array 100. Alternatively, a second array may be installed along the height of the tank 100 to provide the means for “power washing” the bottom of the media using high flow, high pressure water. Alternatively, holding members 1008 may be installed on the ZVIF packings 400 as to prevent the ZVIF packings 400 or other media from being displaced by the distribution array 1000 or fluid flow 212. The carrier 800 may be employed to provide a spacing 1012 between the array 1000 and the ZVIF packings 400 to create a water/media interface. Alternatively, the horizontal and vertical members 1002, 1004 may be translated along the circumference or the members may increase or decrease their diameters as to displace the water coaxially along the media. For example, the holes 1010 may located or concentrated along a particular region of the members for transmission of the fluid flow, and once a particular area or circumference of the metal fabric media has been oxidized, the members may be translated to an inner portion or outer portion of the circumference or area of the metal fabric media that is un-oxidized.

In another embodiment, the distribution array 1000 may be rotated from a central axis 1001 in the array 100. Alternatively, the holes 1010 may be coupled with nozzles penetrating the media or ZVIF packings 400. Rotating the array 1000 and/or use nozzles that spread the water flow through a given diameter spread within x-distance from outlet or the central axis, such that the full surface of the ZVIF packing receives equivalent flow and pressure of water. For example, if the nozzles emit a jet stream, then a tunnel will be created through the ZVIF packing; wherever receives more pressure will result in localized ZVIF packing deterioration at those points. As such, water flow and water pressure is distributed evenly onto the face of the ZVIF packing or media, and thus however the ZVIF packing deteriorates, the deterioration should be evenly distributed over the full surface heading down (or up, if flow is bottom to top). In other embodiments, the array 1000 may oscillate back and forth through 45 degrees (based on a cross configuration for location of nozzles, thus reaching all points orthogonal to the nozzles); full circular movement of array 1000; staggered placement of nozzles on array coupled to oscillation to result in full coverage. Mechanical nozzles may also oscillate themselves and sweep out a defined area between the water/media interface.

When the holes in the array point downward, it may avoid low & high pressure areas, thus minimizing preferential flow at the water/media interface. Pointing the nozzles (holes) downward avoids the localized oxidation (or tunneling effect). When draining the treatment tanks, having the holes/nozzles facing down keeps them from becoming plugged by oxides coming off the media. Alternatively, the nozzles may be pointed or directed at angle with respect to the vertical axis of the treatment tank, whilst maintaining a downward effect and avoidance of oxides from the metal fabric media.

Where multiple inserts 812 are employed in treatment tanks 100, low flow or dead areas of water flow 212 may be created in the tank 100. In one embodiment, a plurality of baffles 1020 may be employed to direct or blank water flow to ¾ or more of one side of the bottom-most insert (see FIGS. 7R-7S). In one embodiment, the plurality of baffles are installed to the inner surface of the treatment tank 100 in a parallel fashion relative to the horizontal axis of the treatment tank 100, or perpendicular to the wall of the treatment tank 100. Alternatively, the plurality of baffles 1020 may be installed in a non-parallel fashion relative to the horizontal axis of the treatment tank 100, or in a non-perpendicular manner relative to the wall of the treatment tank 100. In another embodiment, the adjacent baffles 1020 may be inserted in the treatment tank on the opposite side of each other, such that the next insert is arranged 180 degrees from the position of the previous insert. This insert 812 pattern may be used for all subsequent inserts 812; thus forcing water to flow in a serpentine pattern as it moves up and through the media.

At 20 gpm, the linear water moves up and through the media at only about ⅞ inch per minute, thus even pressure at the water/media interface and designing the media & tank such that water flows evenly through the media. The vertical flowing tubes may be displaced horizontally or along different portions of the circumference of the treatment tank, as to permeate un-oxidized areas of the metal fabric media. In addition to water flowing vertically, water flowing horizontally in tightly packed tubes or arrays may be employed. The horizontally flowing water flow may be displaced vertically, as to permeate un-oxidized areas of the metal fabric media.

### EXAMPLES

The following examples are put forth so as to provide those of ordinary skill in the art with a complete disclosure and description of how the processes, apparatuses, systems, and/or methods claimed herein are made and evaluated, and are intended to be purely exemplary and are not intended to limit the scope of processes, apparatuses, systems, and/or methods. Efforts have been made to ensure accuracy with respect to numbers (e.g., amounts, temperature, etc.), but some errors and deviations should be accounted for.

### Example 1

### Field Test

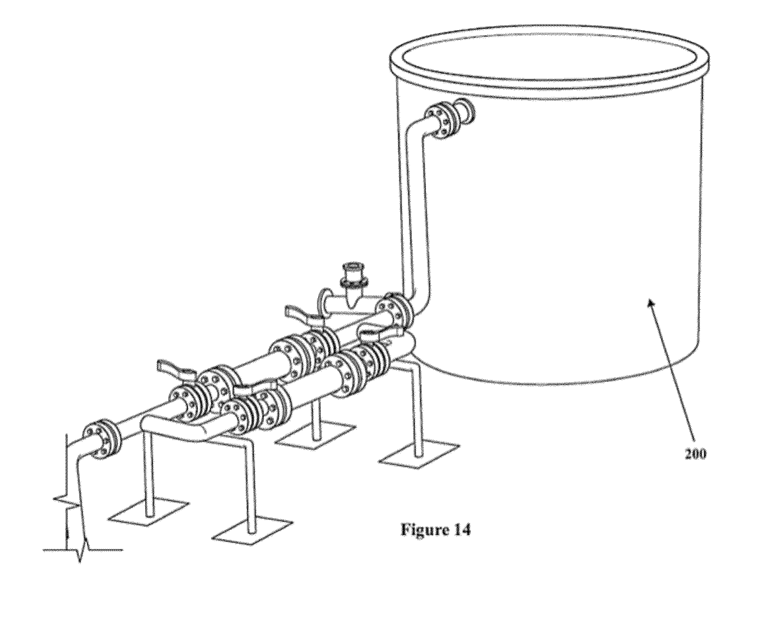

A field demonstration using ZVIF packing with a metal fiber 410 with an average fiber width of 50 μm in a nominal 1850 gallon container vessel 200 was evaluated, as shown FIG. 14. The container vessel 200 was installed at a surface mine and included a top-in inlet port. Piping was attached to divert mine drainage water from a pond into the top of the container vessel. The container vessel 200 was initially filled with 420 pounds of ZVIF packing 400.

A container vessel 200 was installed that allowed top inflow and gravity exit of the mine water. The flow was roughly controllable by a valve at the outlet port. The container vessel 200 measured 6.8 feet in diameter and was 6.9 feet high. The container vessel 200 footprint measured 36 square feet. The ZVIF packing was loosely packed in the tank. Initially 420 pounds of ZVIF packing was loaded to a height of 5.5 feet. Over time the fill of the ZVIF packing settled and another 180 pounds was added, which filled the container vessel 200 to a height of 5.7 feet.

The inflow to and outflow from the container vessel 200 were tested approximately weekly for pH, selenium, iron, aluminum, and manganese concentrations. The contact time of the contaminated water with the ZVIF packing, or the residence time of the mine water can be roughly determined by calculating the volume in gallons of the bed, then determining the time it would take to displace that volume at the flow rate. This method suffers from inexact flow measurements over time (and deviations from perfect flow, such as channeling), but leads to residence times of from a little over one hour up to 16 hours. The great majority of the residence times were from 2.5 to 7.5 hours.

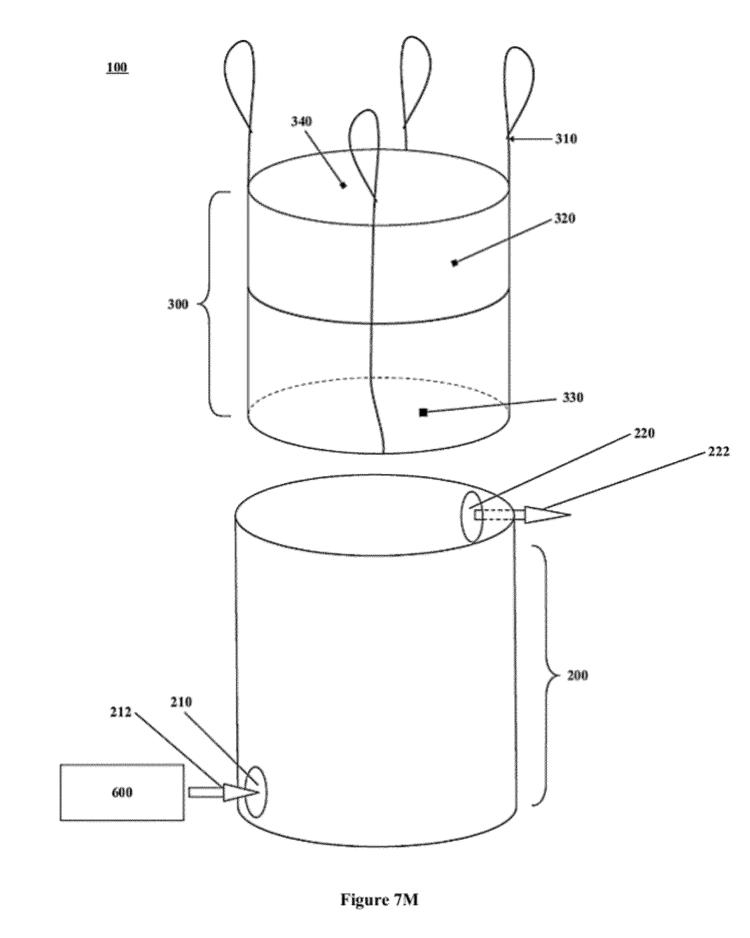

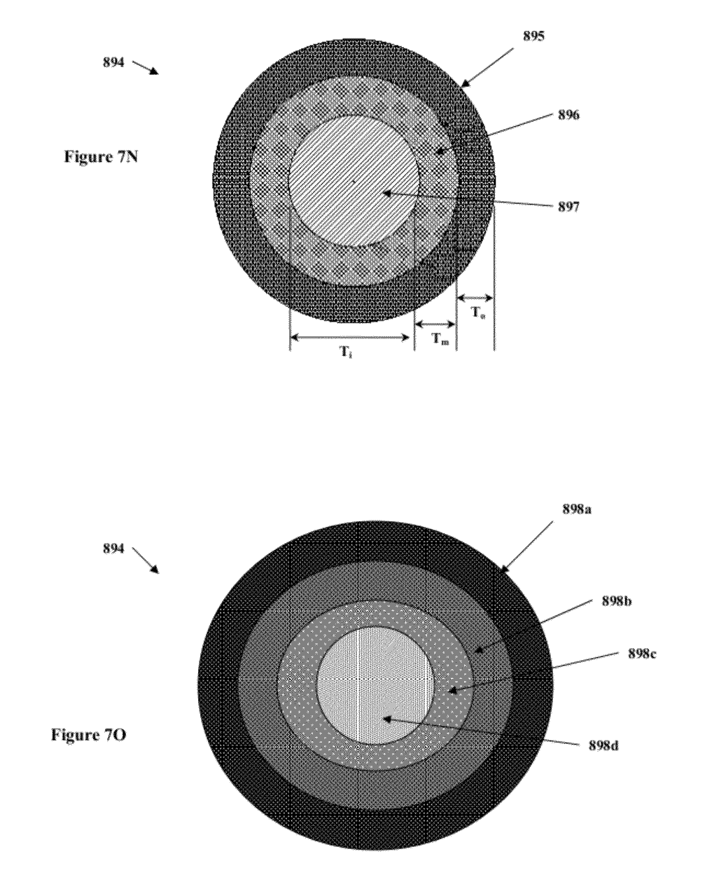

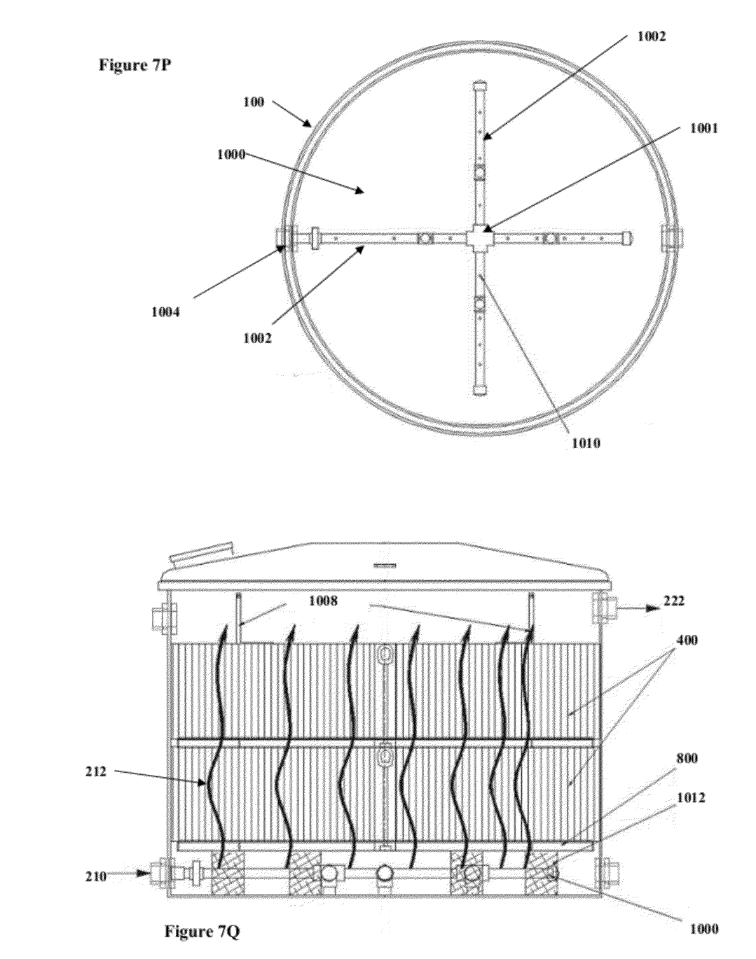

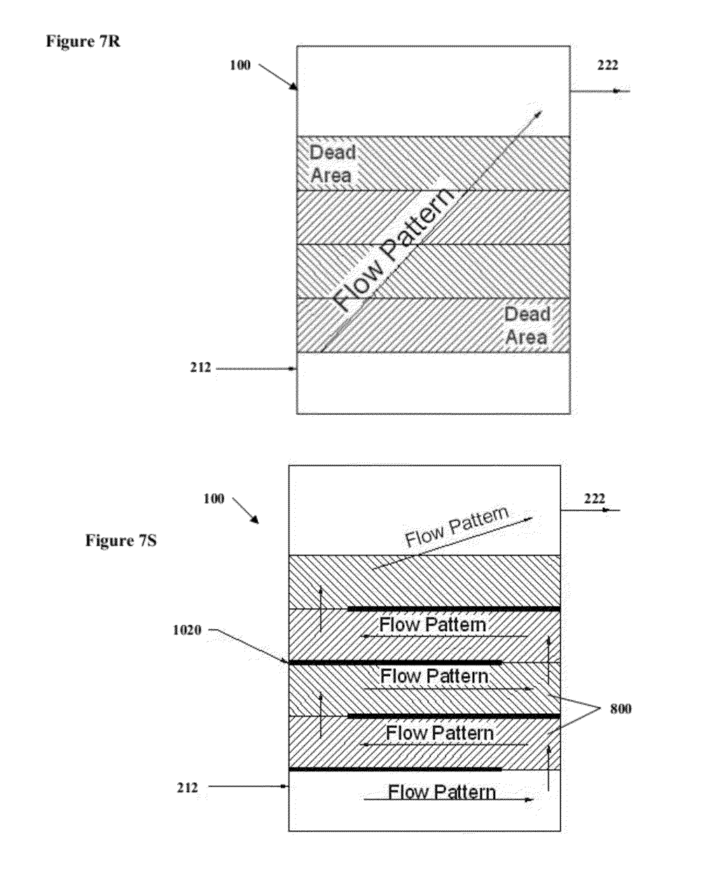

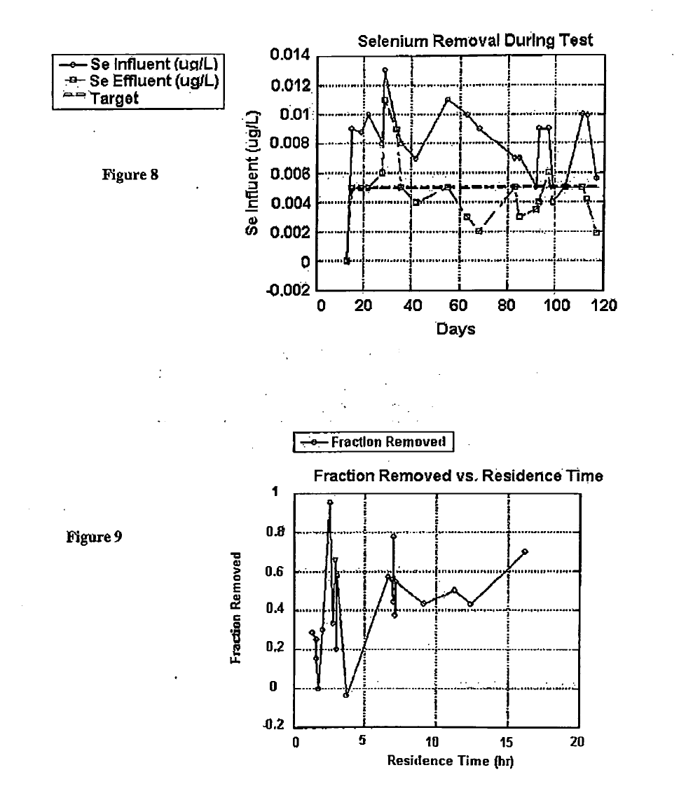

As shown in FIG. 8, a plot of the selenium influent and effluent over time shows that in most instances, selenium is reduced below the 5 μg/L target level over a 120 day period.

Other, more diagnostic relationships were also evaluated, notably the fraction of Se removed as a function of residence time, as shown in FIG. 9. FIG. 9 shows a general trend towards a higher fraction removed at higher residence time, but there are large fluctuations at low residence times and limitations in the chemical analyses. The conclusion that a greater than 40% of the selenium was removed from the treatment system at residence times longer than five hours is demonstrated.

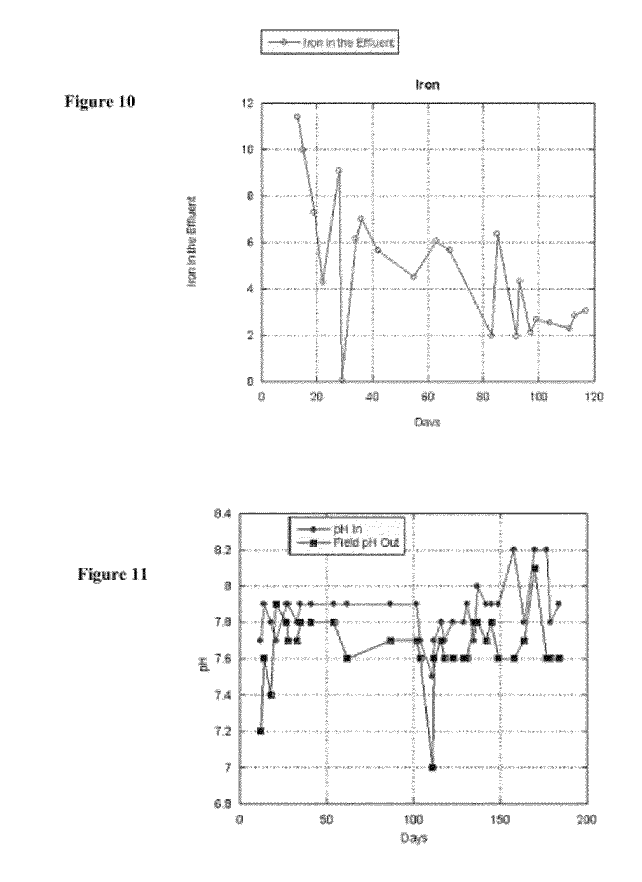

In addition to Se removal, the system released iron. Introduction of oxygen, and the actual reaction of the iron with the Se to a much lesser extent, will oxidize Fe metal to certain ferric oxides. The iron in the influent was usually immeasurable (<0.05 mg/L) but between 2 and 11 mg/L iron was in the effluent, as shown in FIG. 10. Analysis of the iron in filtered and unfiltered samples showed that all added iron was in the solid form. FIG. 10 shows a trend towards lower iron output with increasing time. This may indicate an improved inflow design or some decrease in the access of oxygen to iron, such as might occur if iron oxides coated the fiber particles.

Using the iron numbers and integrating over time shows that 47.5 pounds of the original 600 pounds of iron has been discharged. The integration is imprecise, but strongly indicates the rate of bed deterioration. The integration assumed that the flow and iron concentration were constant over the time period between measurements. The total iron loss as a result of measuring the outflow indicated that of the order of 10% of the iron is lost over a 4 month period. This is a manageable loss from the bed, and the iron discharge, since it is in solid form, can be removed by settling. No reports were given of any clogging in the system due to iron.

As shown in FIG. 11, a plot of the pH of the system showing influent and effluent, and drop of pH between the influent and effluent. The pH of the entry water was about 8 (which can support very little dissolved iron). The pH of the solution tends to decrease marginally, from about 8 to 7.5. The oxidation of metallic iron by oxygen, and its subsequent precipitation, produces protons that lower the pH, as in Equations (4) and (5). This is consistent with the generation of protons during the oxidation and precipitation of iron hydroxides in the bed.

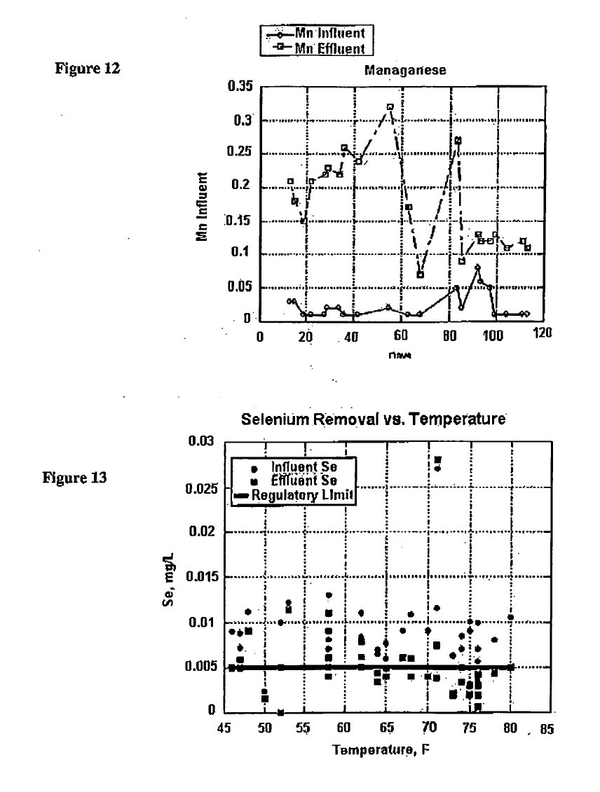

The generation of manganese during treatment is shown in FIG. 12. The ZVIF packing contains manganese to the level of a percent or more which oxidizes during the treatment process. The mechanism of manganese oxidation is unknown, but the amount released is roughly 1% of the amount of iron released, which is a fair indication that manganese is oxidized with iron. The amount of manganese released, as with iron, seems to decrease and stabilize over time.

As shown in FIG. 13, a plot of the selenium removal versus the temperature profile. The plot shows rate effect of temperature on the selenium removal process.

The treatment test has consistently removed selenium from the incoming stream and in most instances to below 5 μg/L, despite imprecise flow control. Low flow rates and long residence times were consistently effective in removing selenium. Certain higher flow rates and shorter residence times were surprisingly effective, but selenium removal at short residence times in this test was unreliable. On occasion, some low residence times, as shown in FIG. 9, provide 50% removal rates. Treatment at 7 gallons per minute lowered the selenium content to 2 μg/L. The rate of bed deterioration is slow and manageable. The release of manganese is not substantial. Manganese, if it presents a problem, does have a known treatment chemistry, whereas selenium does not. Efforts to use low manganese source materials maybe the easiest solution. The treatment of selenium with zero-valent iron under field conditions is effective.

### Example 2

### Controlled Field Test

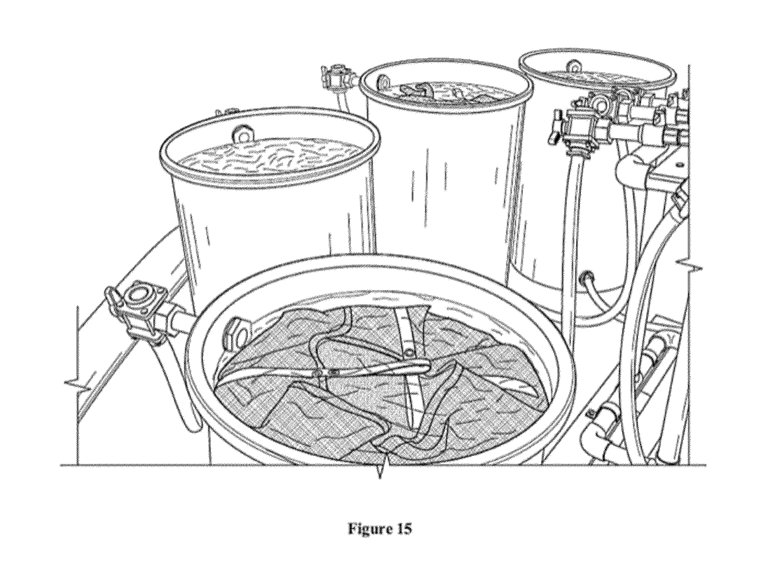

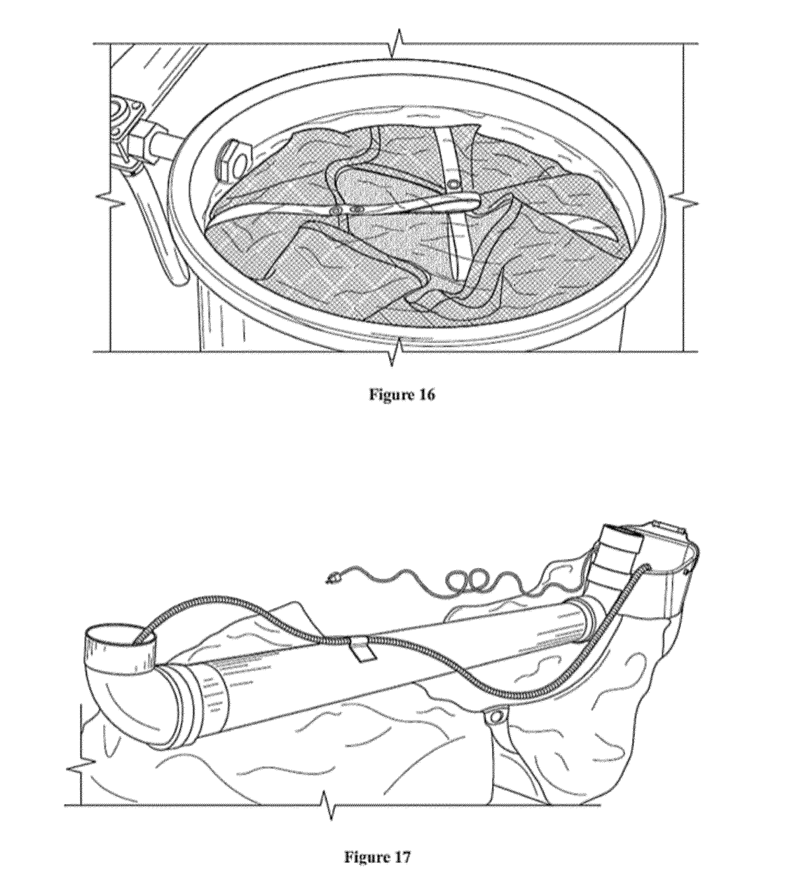

Five Fifty five gallon treatment cells 100 of ZVIF packing 400 were installed in a different surface mine, as shown in FIG. 7A. The five treatment cells contained a ZVIF packing 400 as follows: (1) 0.5 volume % of metal fibers 410 with a cross-section diameter d of 40 μm; (2) 1 volume % of metal fibers 410 with a cross-section diameter d of 40 μm; (3) 2 volume % of metal fibers 410 with a cross-section diameter d of 40 μm; (4) 1 volume % of metal fibers 410 with a cross-section diameter d of 60 μm; and (5) 1 volume % of metal fibers 410 with a cross-section diameter of 100 μm. A significant portion of the test involved establishing the hydraulics, so few chemical tests were plotted. At every residence time (all were near one hour) for the same fiber diameter, the higher density ZVIF packing 400 removed measurably more selenium. For the metal fibers with a cross-section diameter d of 40 microns, the 0.5 volume % treatment cell removed 11.7% of the incoming selenium at a 1.1 hour residence time. The 1 volume % treatment cell removed 25.5% at a residence time of 0.83 hour. The 2 volume % treatment cell removed 56.4% at a residence time of 2 hours. Maintaining high flow in the most densely packed treatment cell was difficult. The treatment cell packed with 1 volume % of metal fibers 410 with a cross-section diameter d of 60 μm removed 10.6% of the selenium with a residence time of 0.86 hour. The treatment cell filled with 1 volume % of metal fibers 410 with a cross-section diameter of 100 μm removed 13.8% of the selenium with a 0.86 hour residence time. No obvious fiber diameter dependence is seen for the last two treatment cells, but the 1 volume % 40 μm treatment cell removed 25.5% of the selenium as noted above. For reference, the other removal test contained 0.5 volume % of metal fibers 410 with a cross-section diameter d of 50 μm. These controlled drum tests reaffirm the removal of selenium by ZVIF and utilized the full treatment cell 100, notably use of the porous bags 300. FIG. 15 shows the fifty-five galloon treatment cell after 6 weeks of use.

### Example 3

### Bench Scale Evaluation of Zero-Valent Iron

The evaluation of zero-valent iron (iron metal) as a reductant for Se(IV) and Se(VI), where the product should be elemental Se(0).

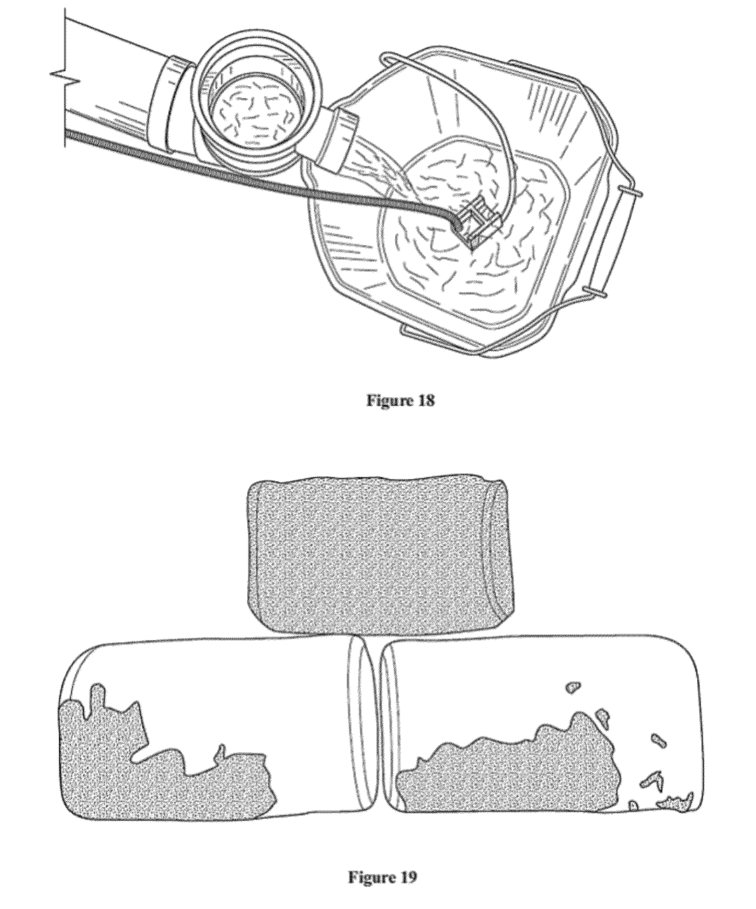

The system used consists of a five (5) foot length of 4 inch inside diameter Polyvinyl Chloride (“PVC”) drain pipe with a 90 degree bend at both ends, as shown in FIG. 17. The exit end of the pipe also had a straight extension with a three (3) inch reduction output at 90 degrees, as shown in FIG. 18. A 120 gallon-per-hour submersible pump was used to recycle the mine drainage. The effluent was sampled and analyzed for Se and other metals at designed intervals.

The rate of selenium removal was 24 μg of Se/hour for the interval of 0-1 hours; 5.8 μg of Se/hour for the interval of 0-8 hours; 4.9 μg of Se/hour for the interval of 0-12 hours; and 3 μg of Se/hour for the interval of 6-12 hours. The ZVIF packing pads after the bench test are shown in FIG. 19, where the top ZVIF packing pad is a coarse pad and the two bottom ZVIF packing pads are an extra fine pad. FIG. 20 is a plot of the initial Se removal portion fit to an exponential curve for 0-6 hours. FIG. 21 is a plot of the selenium removal for 6-12 hours showing linear removal rates.

### Example 5

### Helical Wound Zero-Valent Iron Reel

The metal fibers 400 may include a helical wound reel configuration, wherein the helical wound reel includes layers of isotropic metal fibers helically wound about a center or core to form a helical wound reel in a cylindrical or puck-like shape. The helical wound reel may then be placed into a PVC tube in a concentric fashion, or alternatively be placed on top each other to form a fluid flow through for treating contaminated water when coupled with a water pump. The metal fibers 400 are produced in an isotropic mass as indicated previously, and then the metal fibers 400 are helically wound into a master helical roll onto a 2″ diameter cardboard core. Master helical rolls are approximately about 4″ wide×24″ in diameter and weigh about 20 lbs. The approximate densities of the master helical rolls are about 18 lbs per cubic foot.

The master helical roll is then taken to a reeling machine to be made into finished helical wound reels including a correct width, tension, weight and diameter. The core of the master helical roll is placed on a shaft at the beginning of the reeling machine and a 1″ diameter by 10.5″ long PVC core is placed in the reeling machine's bobbin. The ribbon from the master helical roll is threaded through a tensioner, a device that applies a force to an object to maintain it in tension, and hand wrapped onto the 1″ PVC core. The tensioner may include a series of polls in which the ribbon may be wrapped around to apply a tension force. An operator uses a foot pedal that starts the reeling machine's bobbin to spin and helically wrap the ribbon of the master helical roll around the PVC core. The reeling machine may operate at a speed of about 50-70 rpm and the reeling machine's speed is controlled by foot pedal as an on/off function. The reeling machine includes a pressure pad on the opposite of the feed side of the reeling machine that is set to about 20-50 psi, which works with the operator to control the tension of the ribbon. The operator guides the ribbon of the master helical roll while adjusting the reeling machine's speed in order to make the helical wound reel to a particular finished specification. When the helical wound reel reaches a particular specification, the operator stops the reeling machine, cuts the helical wound reel from the master roll, and takes the finished helical wound reel off the bobbin. A 1″ diameter plastic plug is placed in one end of the helical wound reel's core to eliminate fluid flow through the core. The specification for the finished helical wound reels is approximately 20 lbs, 10.5″ wide×11.5″ in diameter for an approximate density of 32 pounds per cubic foot. The finished helical wound reels can be larger or smaller in diameter and width as well as higher or lower in density in order to adjust for element or selenium removal. For example, the finished helical wound reels may include a range of about 8″ to 24″ in diameter, 4″ to 16″ in length, and 15 to 50 pounds per cubic foot in density. There is no minimum or maximum pitch for the helical wound reels; however, the pitch may range from about ⅛″ to ⅜″.

In one example, eleven of the 20-lb finished helical reels are loaded into a 12.75″ OD×11.29″ ID schedule 80 PVC tube. A complete treatment system would use several PVC tubes either in series or in parallel. Alternatively, the finished helical wound reels may be placed in any type of enclosure with a fluid flow through system, including, but not limited to a tank bale, a pipe, and the like.

### Example 6

### Seven Tank Se Removal Test

Grade 0/1 metal fibers were used from line 2A except for Metrix reel which used GSP grade 0 metal fibers. Seven treatment tanks started with a 0.0625 μg/L Selenium Concentration in the fluid flow and samplings of selenium concentration was taken at 20 minute intervals. The tanks were run for approximately 4 weeks prior to this test at a flow rate of 2.0 gpm per tank.

Tank 1=Carbon steel of varying density; less interior density, more exterior density (100% outside, 80% middle, 70% inside) 45 lb ZVIF packing total. Tank 2 has 9:1 carbon steel to poly fibers, 55 lb reel; 50 lb of ZVIF packing Tank 3 Has a 12″ grade 3 reel on bottom and 12″ grade 0 reel on top; 50 lb ZVIF packing total. Tank 4 has 8-9 (½″) holes along the bottom third of the core, several rows of holes across several columns, plugged bottom; 48 lb ZVIF packing total. Tank 5 is a control reel that will have its flow reversed at some point in the future (when Se removal deteriorates); 50 lb ZVIF packing total. Tank 6 has a control insert with a 21′5″ OD×17.5″ ID ring on the bottom that only allows flow through the ring. 48 lb ZVIF packing total. Tank 7=Carbon steel control insert; 11 lb per cubic foot density. 49 lb ZVIF packing total.

TABLE 1

| | | | Tank 2 | Tank 3 | Tank 4 | Tank 5 | Tank 6 | Tank 7 |
|---|---|---|---|---|---|---|---|---|
| | Time | Tank 1 [Se] | [Se] | [Se] | [Se] | [Se] | [Se] | [Se] |
| # | (mins) | (mg/l) | (mg/l) | (mg/l) | (mg/l) | (mg/l) | (mg/l) | (mg/l) |
| Raw | 0 | 0.0625 | 0.0625 | 0.0625 | 0.0625 | 0.0625 | 0.0625 | 0.0625 |
| 1 | 60 | 0.0062 | 0.0000 | 0.0000 | 0.0110 | 0.0000 | 0.0099 | 0.0120 |
| 2 | 80 | 0.0041 | 0.0000 | 0.0000 | 0.0000 | 0.0000 | 0.0085 | 0.0080 |
| 3 | 100 | 0.0000 | 0.0000 | 0.0000 | 0.0048 | 0.0063 | 0.0086 | 0.0086 |

After normal sampling, tanks 2 & 7 had their flow rates doubled (from 0.84 gpm to ˜1.7 gpm). The tanks were allowed to run for one hour before sampling. The results show that Tank 1 had a 94.51% average percent reduction in selenium concentration in the fluid flow, Tank 2 had a 100% average percent reduction in selenium concentration in the fluid flow, Tank 3 had a 100% average percent reduction in selenium concentration in the fluid flow, Tank 4 had a 91.57% average percent reduction in selenium concentration in the fluid flow, Tank 5 had a 96.64% average percent reduction in selenium concentration in the fluid flow, Tank 6 had a 85.60% average percent reduction in selenium concentration in the fluid flow, and Tank 7 had a 84.75% average percent reduction in selenium concentration in the fluid flow.

TABLE 2

| | | Tank 2 Se | Tank 7 Se |
|---|---|---|---|
| | Time | Concentration | Concentration |
| # | (minutes) | (mg/l) | (mg/l) |
| Raw | 0 | 0.0625 | 0.0625 |
| 1 | 80 | 0.0000 | 0.0160 |
| 2 | 100 | 0.0000 | 0.0150 |

The results show that the average selenium percent reduction in tank 2 was 100% and the average percent reduction in tank 7 was 75.20%.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An apparatus for removing elements from a fluid, comprising:
a. a carrier apparatus operably coupled to a plurality of metal fibers having a zero valence state, wherein the plurality of metal fibers are interengaged with a plurality of nonmetal fibers to form a media fabric including a length, a width, and a thickness;
b. the media fabric is configured in a helical configuration operably coupled to the carrier apparatus, wherein the plurality of metal fibers remove a plurality of elements in a fluid flow of water.

2. The apparatus of claim 1, wherein the ratio of the plurality of metal fibers to the plurality of nonmetal fibers is at least between 10:1 and 2:1 to provide for density of metal fibers throughout the helical configuration.

3. The apparatus of claim 2, wherein the plurality of metal fibers further comprise iron.

4. The apparatus of claim 3, wherein the mass of iron fibers further comprise an irregular cross-section and a rough outer surface with a plurality of projections and fissures formed on the rough outer surface.

5. The apparatus of claim 4, wherein the rough surface area of the mass metal fibers reduces the plurality of elements in the fluid flow.

6. The apparatus of claim 5, wherein the average cross-sectional diameter d of the metal fibers range between about 10 and 500 microns.

7. The apparatus of claim 6, wherein the plurality of elements comprises selenium ions selected from the group consisting of selenate ions and selenite ions.

8. The apparatus of claim 7, wherein the helical configuration further comprises an outer zone, a middle zone, and an inner zone, wherein the outer zone includes a ratio of metal fibers to nonmetal fibers that is greater than the ratio of metal fibers to nonmetal fibers of the middle zone.

9. The apparatus of claim 1, wherein the helical configuration further comprises an outer zone, a middle zone, and an inner zone, wherein the inner zone includes a ratio of metal fiber to nonmetal fibers that is less than the ratio of metal fibers to nonmetal fibers of the middle zone.

10. The apparatus of claim 9, wherein the helical configuration includes an inner core with a central.

11. The apparatus of claim 10, wherein the outer zone includes a packing of metal fibers at a first density D and the middle zone includes a packing of metal fibers at a second density D, wherein the first density D is different than the second density D.

12. A process for removing metal elements from a fluid comprising:
a. passing a fluid comprising a plurality of metal elements to be removed through a plurality of metal fibers including a zero valence state, wherein the plurality of metal fibers are interengaged with a plurality of nonmetal fibers to form a media fabric in a helical configuration; and
b. reacting the plurality of metal elements with the plurality of metal fibers whereby the plurality of metal elements adsorb to the plurality of metal fibers from the fluid.

13. The process of claim 12, wherein the metal fibers comprise zero valent iron.

14. The process of claim 13, wherein the reacting step further comprises the step of reducing the plurality of metal elements in the fluid with the plurality of packed zero valent metal fibers and retaining reduced metal elements within the bales.

15. The process of claim 14, wherein the reduced metal elements are selected from the group consisting of selenium, selenate and selenite.

16. The process of claim 12, wherein the packing density D in the passing step further comprises a packing density D between about 1 to about 10 lbs/gal.

17. The process of claim 12, wherein the average cross-sectional diameter d of the metal fibers range between about 10 and 500 microns.

18. The process of claim 17, wherein the passing step further comprising passing fluid through a tank including a vacuum.

19. The process of claim 18, wherein the helical configuration further comprises an outer zone, a middle zone, and an inner zone, wherein the outer zone includes a ratio of metal fibers to nonmetal fibers that is greater than the ratio of metal fibers to nonmetal fibers of the middle zone.

20. The process of claim 19, wherein the helical configuration further comprises an outer zone, a middle zone, and an inner zone, wherein the inner zone includes a ratio of metal fiber to nonmetal fibers that is less than the ratio of metal fibers to nonmetal fibers of the middle zone.
